(19) United States
(12) Patent Application Publication
(10) Pub. No.: US 2025/0373953 A1
(43) Pub. Date: Dec. 4, 2025

(54) LARGE-SCALE MULTI-ACTOR VOLUMETRIC VIDEO CAPTURE

(71) Applicant: Netflix, Inc., Los Gatos, CA (US)

(72) Inventors: Stephan Trojansky, Henderson, NV (US); Paul Debevec, Culver City, CA (US)

(21) Appl. No.: 18/731,161

(22) Filed: May 31, 2024

(51) Int. Cl. H04N 23/90; H04N 13/111; H04N 13/156; H04N 13/282; H04N 23/51; H04N 23/69; H04N 23/695

(52) U.S. Cl. CPC H04N 23/90; H04N 13/111; H04N 13/156; H04N 13/282; H04N 23/51; H04N 23/69; H04N 23/695

(57) ABSTRACT

A system includes a first structure that houses first cameras, where each camera is controllably moveable in synchronization with second cameras on a second structure and with third cameras on a third, overhead structure. The first, second, and third sets of cameras are controllably directed toward a specified entity. The second set of cameras are controllably moveable in synchronization with the first and third sets of cameras, and the third, overhead cameras are controllably moveable in synchronization with the first and second sets of cameras. The system also includes a controller configured to generate and send control signals to the first, second, and third sets of cameras to track the specified entity as the specified entity moves within a defined space that is observable by the first, second, and third sets of cameras in the first, second, and third structures. Various other apparatuses and devices are also disclosed.

### BACKGROUND

Over the years, video cameras have been increasingly used to capture people, places, and a wide variety of different things. In some cases, video cameras are used to create motion pictures or television shows. In such scenarios, directors may film different types of scenes from a variety of different angles. Each camera used for a given scene has its own output or “video feed.” Each video feed would be independent of the other video feeds, and the images captured by one video feed would be spliced in front of or behind the images from another video feed. The shots from the various video feeds may then be cut together, in a specific order, to create a scene that is shot from different cameras and different camera angles. Video recording setups of this type, however, are insufficient to record film movies and tv shows in the customizable and organic ways that directors and producers want to capture and present video content.

### SUMMARY

As will be described in greater detail below, the present disclosure generally describes systems and methods for capturing video from a variety of different angles in a synchronous manner and combining the video feeds using dynamically updated operational information associated with the various cameras.

In one example, a system for capturing video is provided. The system includes a first structure configured to house a first set of cameras. Each camera is controllably moveable in synchronization with a second set of cameras on a second structure and with a third set of cameras on a third, overhead structure. The first, second, and third sets of cameras are controllably directed toward at least one specified entity, such as an actor or actress. The system includes the second structure which is configured to house the second set of cameras. Each of these cameras is controllably moveable in synchronization with the first and third sets of cameras. The system also includes the third, overhead structure that is configured to house the third set of cameras. Each of those cameras is controllably moveable in synchronization with the first and second sets of cameras. The system further includes a controller configured to generate and send control signals to the first, second, and third sets of cameras to track the specified entity as the entity moves within a defined space that is observable by the first, second, and third sets of cameras housed in the first, second, and third structures.

In some embodiments, the system further includes at least one modular flooring element, where the modular flooring element includes at least one portion of transparent material and at least one camera underneath the portion of transparent material. In some cases, the camera underneath the portion of transparent material in the modular flooring element is configured to pivot from a central axis to maintain focus on the specified entity. In some examples, the first structure or the second structure may be positioned on the modular flooring element. In some cases, the controller additionally generates and sends control signals to the camera underneath the portion of transparent material in the modular flooring element to track the specified entity as the specified entity moves within the defined space.

In some examples, the system further includes at least one dynamic ceiling element that is part of a dynamic ceiling. The dynamic ceiling element includes a structural component and at least one controllably moveable camera mounted thereto. In some embodiments, the structural component of the dynamic ceiling element is configured to telescope upward or downward relative to the dynamic ceiling. In some cases, the dynamic ceiling includes multiple telescoping, dynamic ceiling elements, each with controllably moveable cameras attached thereto. In some examples, the telescoping, dynamic ceiling elements dynamically telescope upward or downward based on a current position of the specified entity. In some cases, the telescoping, dynamic ceiling elements include vertical actuators that activate telescoping upon receiving a specified control signal.

In some embodiments, at least one of the cameras in the first, second, or third sets of cameras includes a motorized zoom lens. In some cases, at least one of the cameras in the first, second, or third sets of cameras includes an infrared light sensor configured to detect textures associated with the specified entity.

In some cases, the system further includes at least one laser configured to track movements of and follow the specified entity. In some embodiments, the first, second, and third sets of cameras are configured to track a plurality of specified entities as the specified entities move within the defined space that is viewable by the cameras housed in the first, second, and third structures.

In some examples, the first structure, the second structure, and/or the third structure are mobile. In some embodiments, the controller directs the first structure, the second structure, and/or the third structure to follow and maintain a specified distance away from the specified entity. In some embodiments, the system further includes a processor configured to stitch video feeds from the first, second, and/or third sets of cameras into a combined video feed. In some cases, the processor uses the combined video feed to create a three-dimensional model of the specified entity.

In another example, an apparatus for capturing video is provided. The apparatus includes a first structure configured to house a first set of cameras. Each camera is controllably moveable in synchronization with a second set of cameras on a second structure and with a third set of cameras on a third, overhead structure. The first, second, and third sets of cameras are controllably directed toward at least one specified entity, such as an actor or actress. The apparatus includes the second structure which is configured to house the second set of cameras. Each of these cameras is controllably moveable in synchronization with the first and third sets of cameras. The apparatus also includes the third, overhead structure that is configured to house the third set of cameras. Each of those cameras is controllably moveable in synchronization with the first and second sets of cameras. The apparatus further includes a controller configured to generate and send control signals to the first, second, and third sets of cameras to track the specified entity as the entity moves within a defined space that is observable by the first, second, and third sets of cameras housed in the first, second, and third structures.

In a further example, a video capture device is provided. The video capture device includes a first structure configured to house a first set of cameras. Each camera is controllably moveable in synchronization with a second set of cameras on a second structure and with a third set of cameras on a third, overhead structure. The first, second, and third sets of cameras are controllably directed toward at least one specified entity, such as an actor or actress. The video capture device includes the second structure which is configured to house the second set of cameras. Each of these cameras is controllably moveable in synchronization with the first and third sets of cameras. The video capture device also includes the third, overhead structure that is configured to house the third set of cameras. Each of those cameras is controllably moveable in synchronization with the first and second sets of cameras. The video capture device further includes a controller configured to generate and send control signals to the first, second, and third sets of cameras to track the specified entity as the entity moves within a defined space that is observable by the first, second, and third sets of cameras housed in the first, second, and third structures.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example embodiment of a video capture system including a plurality of different cameras operating in a synchronous manner.

FIG. 2 illustrates an embodiment of a top view of a video capture system including a plurality of different cameras operating in a synchronous manner.

FIG. 3 illustrates an alternative embodiment of a video capture system including a plurality of different cameras operating in a synchronous manner.

FIG. 4 illustrates an embodiment of a side view of a video capture system including a plurality of different cameras operating in a synchronous manner.

FIG. 5 illustrates an embodiment of a video capture cart that includes a plurality of different cameras operating in a synchronous manner.

FIG. 6 illustrates an alternative embodiment of a video capture system including a plurality of different cameras operating in a synchronous manner to simultaneously capture a plurality of actors or actresses.

FIGS. 7A and 7B illustrate an alternative embodiment of a video capture system including a plurality of different cameras in motion, capturing an entity on video.

FIG. 8 illustrates an embodiment of a modular flooring component including a plurality of different panels that allow video capture from the ground upward.

FIGS. 9A and 9B illustrate an embodiment of a controllably moveable camera in a modular flooring component.

FIGS. 10A and 10B illustrate an embodiment of a dynamic ceiling that includes controllably moveable cameras that capture different aspects of an entity.

FIGS. 11A and 11B illustrate an embodiment of a vertical actuator that may be implemented within the dynamic ceiling.

FIG. 12 illustrates an embodiment of a motorized lens that may be implemented within the cameras described herein.

FIGS. 13A-13C illustrate an example embodiment of a mobile video capture system including a plurality of different cameras operating in a synchronous manner.

FIG. 14 illustrates an alternative example embodiment of a mobile video capture system including a plurality of different cameras operating in a synchronous manner.

FIG. 15 illustrates a flow diagram of an exemplary method for implementing ML models to predict how feedback loops will be negatively affected over time.

FIG. 16 illustrates an embodiment in which rolling shutters and global shutters are used to improve lighting.

FIG. 17 is a block diagram of an exemplary content distribution ecosystem.

FIG. 18 is a block diagram of an exemplary distribution infrastructure within the content distribution ecosystem shown in FIG. 17.

FIG. 19 is a block diagram of an exemplary content player within the content distribution ecosystem shown in FIG. 18.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to systems and methods for capturing video from a variety of different angles in a synchronous manner and combining the video feeds using dynamically updated operational information associated with the various cameras. In some cases, the system is stationary, while in other cases, the system is mobile and is configured to move with the persons or objects being captured on video.

As noted above, video capture has been used to capture actors and actresses to create films, television shows, documentaries, or other artistic works. In some cases, directors of these artistic works may set up different cameras to shoot a given scene from different angles. In such systems, each camera works in isolation to capture the scene from its designated position. In some cases, the camera may be on a camera rig that is configured to move alongside the actors within a limited space. Such cameras may capture video information from the side of the actors or actresses but will not capture video information from the top or from below or from behind the actors, actresses, or other objects. Such video information has typically been lacking in scenes filmed with a single camera or even in scenes filmed with multiple cameras positioned at different angles.

In some cases, in order to capture this additional, three-dimensional coverage of an entity being filmed, that entity may have been confined to a seated, non-moving position. In such cases, multiple cameras would be positioned toward an actor or actress, but that person would need to stay in a highly confined space (e.g., stay sitting on a chair) and perform their acting in a highly unnatural position. This unnaturalness would be heightened if the scene attempted to involve more than a single person. Indeed, setups involving multiple simultaneous cameras were not able to track the movement of actors or actresses and were especially unable to capture the movement and interactions of multiple people at the same time.

In contrast, the embodiments herein may include systems, apparatuses, video capture devices, and methods that allow filmmakers, directors, or other artists or users to capture video in a volumetric manner that captures video information related to a given entity (or entities) from many different cameras (e.g., hundreds or thousands of cameras). The systems herein then combine the video feeds from these many cameras into a single video feed or into a recorded three-dimensional model of the entity that is based on some or all of the video feeds from the various cameras. This may allow the filmmaker or other artist to capture a person's or a group's actions in a much more immersive and comprehensive manner.

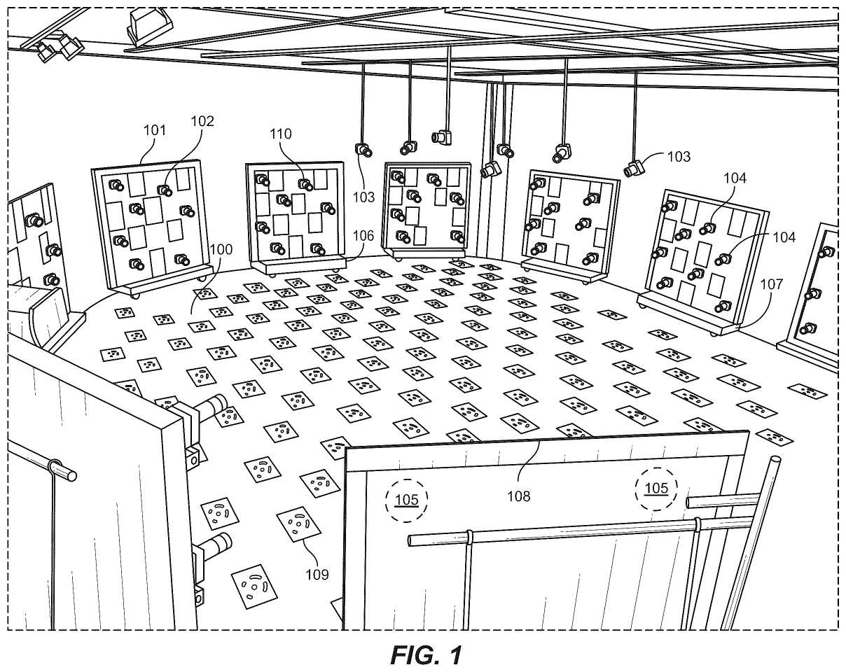

The video feeds from the various cameras may be stitched together or combined based on camera settings and operational information from each camera as the operational settings change over time. Moreover, the systems herein may be configured to identify an entity and track that entity as the entity moves within a space that is observable by the various cameras. This ensures that the entities' facial expressions, emotions, and movements are captured with clarity and detail, from a variety of different angles. These systems and methods will be described in greater detail below with reference to FIGS. 1-18.

FIG. 1, for example, illustrates a video capture system 100 that is configured to capture an entity's movements within a defined space. As the term is used herein, an “entity” may refer to the subject or group of subjects that are to be captured by the cameras. This entity could be a person (e.g., an actor, actress, stunt person, extra, or other person), an object (e.g., a football, a ring, a chair, a key, a flower, a car, a dog, or any other object that is to be captured on video), or any other item that may be captured on video. In some cases, for simplicity's sake, the entity will be referred to as an actor or as an actress or as an object, although any entity could be substituted in its place.

In some embodiments, an actor is surrounded by multiple different panels or carts (e.g., 101, 106, 107, 108). Each of these carts includes a plurality of cameras. For example, cart 101 has cameras 102, cart 106 has cameras 110, cart 107 has cameras 104, and cart 108 has cameras 105. Other carts are also shown, each with their own set of cameras. While the carts shown in FIG. 1 each have eight to ten cameras, it will be understood that the carts may include substantially any number of cameras. Moreover, while approximately ten carts are shown in this embodiment, it will be understood that the systems herein may operate with two or more carts and that there may be any number of carts in a single video capture implementation. In addition to these carts, multiple cameras may be positioned overhead. For example, the video capture system 100 may include multiple overhead cameras 103.

Each of the cameras in the video capture system 100 is controllably moveable within the system. As the term is used herein, “controllably moveable” refers to each camera's ability to be repositioned, in real time, by adjusting tilt, swivel, zoom, or other type of movement. The movements of the cameras occur in response to control signals generated by an electronic controller (not shown in FIG. 1). The electronic controller is connected, either in a wired manner or in a wireless manner, to the cameras. The controller sends control signals to and receives data from the cameras in the carts (e.g., 101 or 106). The control signals may indicate, for example, that the camera (e.g., which may be mounted on a gimbal or other pivoted support system) is to zoom in further, zoom out, pan left or right, tilt upward or downward, or some combination thereof. The camera may include a wired or wireless network card configured to provide information to the controller, including current zoom level, current tilt angle, current pan measurement, current focal ratio or F-stop, current light amplitude, or other operational or environmental information.

In this manner, the controller sends control signals to the cameras to control their movements and current subject of focus. In some cases, the cameras are controlled as a unit. For instance, a controller may instruct the cameras to track or follow, as a group, a single actor or a group of different actors. In some cases, for example, an actor may wear detectable electrodes or will wear detectable patterns or markers or will have other electronic, visual, or machine-visible (e.g., infrared), detectable patterns that identify the entity that is to be tracked by the cameras.

Once the entity has been identified, the controller then uses information and video feeds from the cameras to track the entity as it moves within a defined space that is observable by the video capture system 100. In some cases, the controller sends control signals to the various cameras in the carts, attached to overhead poles, and potentially in floor-based platforms. Using these control signals, the cameras track the entity as he/she/it moves within the defined space. In this manner, the entity is recorded or filmed from the sides, from above, and from below, regardless of where the entity moves within the defined space. This allows filmmakers to capture high resolution, high light amplitude, high fidelity representations of each entity in a given scene.

For instance, when a camera is further away from an actress and the lens is further zoomed out, that lens will capture less light reflecting from the actress. As such, that camera may not receive enough light for a high fidelity, high resolution (e.g., 4K or 8K) representation of the actress. Other cameras within the defined space, however, will be closer to the actress, and will be able to capture high resolution representations of the actress' face, for example. Cameras that are further away capture other aspects of the actress, allowing some video feeds from some cameras to be used for visual closeups of the actress' face, while video feeds from other cameras can provide top and side information, wardrobe, background, movement, and other relevant information. In this manner, the cameras of the video capture system 100 may work together to allow filmmakers to capture video in an innovative manner that captures sufficient light to present high resolution closeups while also providing a high level of detail on surrounding and related items.

In some embodiments, as will be explained further below, portions (or all) of the flooring 109 may have cameras embedded therein. In some cases, the flooring 109 is made of modular components that are large enough to house a full-size film camera (e.g., 1-2 ft. in height). In some cases, the floor cameras are moveably or rotatably fastened to a gimbal, to a hinge, or to another mechanism that allows the camera to pan, tilt, zoom, or otherwise move to follow the actress or other entity. In some cases, the modular flooring component includes different types of tiles. Some of these tiles may be opaque and may have a grippier surface, while other tiles may be less grippy, but may be transparent and, thus, allow light to reach a camera that sits below the transparent tile.

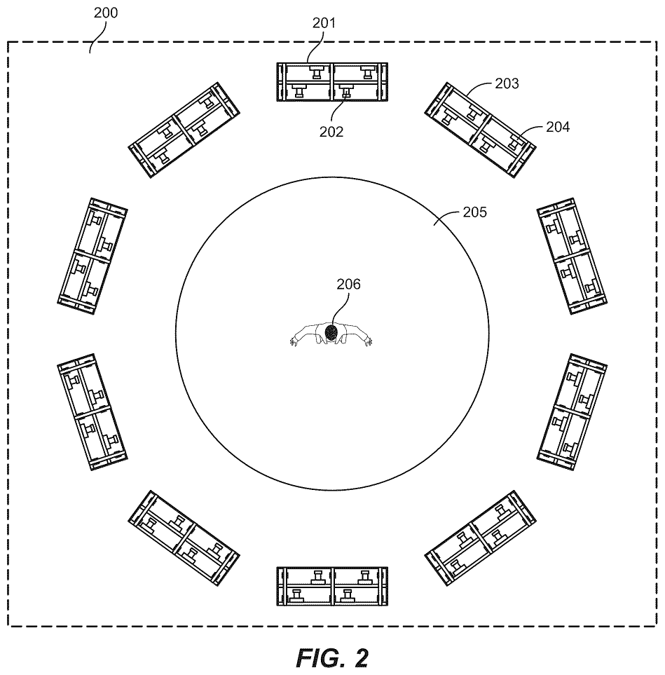

FIG. 2 illustrates an embodiment 200 in which an entity such as an actor 206 is surrounded by multiple carts. Each of these carts (e.g., 201, 203) has a plurality of different cameras (e.g., 202, 204). The cameras are positioned at different levels, on different sides of the cart, and at different heights. In one embodiment, a cart may have four rows of cameras, with three cameras on each row. The cameras may be staggered or offset, such that the cameras of one row are not directly on top of the cameras in a different row but are rather offset from each other. In some embodiments, a single controller or set of controllers may control the movement and/or operational settings of each of the cameras in a single cart, in a group of carts, or in all of the carts (in this embodiment, all 10 carts).

The controller(s) may individually control the zoom, pan, tilt, frame capture rate, focal ratio, or any other controllable movement or operational setting of each camera separately. Thus, even though the cameras are being controlled as a group to track the actor 206 within a defined space 205, each camera is individually controlled to focus on certain aspects of the actor or items related to the actor. For instance, some cameras (e.g., 202, 204) are focused on the actor's face, or focused on the actor's clothing, or on the actor's hands, or on an object being held by the actor, or on some other specific action or characteristic of the actor. Zoom, pan, tilt, frame capture rate, or other operational settings for any single camera or group of cameras or for all of the cameras may be initially set and then dynamically updated as the actor 206 moves around within the defined space 205.

For instance, in some cases, the actor 206 will interact with another actor or actress or object within the defined space 205. Some of the cameras are controlled to focus on the actor 206, while other cameras are configured to focus on the other actor, actress, or object. Thus, in a given cart (e.g., cart 203), half of the cameras may be directed at the actor 206, while the other half are directed to the other entity in the defined space 205. The ratio of cameras focused on any one entity may also be dynamically chosen and carried out by the controller. The underlying system may determine that, for some moments, the actor 206 is the most important part of the scene, and so 75% of the cameras are focused on the actor for that time period, while 25% of the cameras are focused on the other entity.

As the scene progresses, importance may shift to the other entity, and correspondingly, 80% of the cameras would be controlled to shift their focus to the other entity, while 20% of the cameras would be controlled to focus on the actor 206. Thus, even after initial settings and foci have been given, the controller may make continual updates as to who or what the cameras are focused on, which percentage of cameras are focused on that entity, and how the cameras are moved or repositioned (e.g., pan, tilt, zoom, etc.) to follow that actor 206 or other entity.

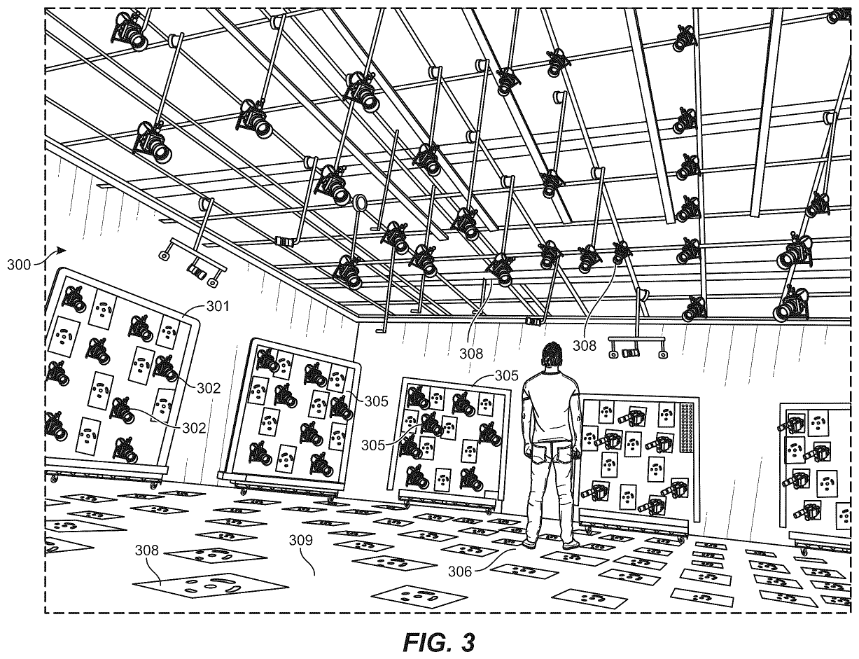

FIG. 3 illustrates an embodiment that provides a floor-level view of a system 300 for capturing video. Like the system in FIG. 1, the system 300 of FIG. 3 includes a plurality of panels or carts (e.g., 301, 304, etc.). These carts may have wheels that allow the carts to be positioned and repositioned as needed. The carts may include support structures configured to hold multiple cameras (e.g., 302, 305, etc.). Each of these cameras is individually controllable by a controller, although at least in some embodiments, the cameras are controlled collectively to focus on and track an actress or actor 306. The actor 306 may be free to move, within the confines of the carts (e.g., 301) around the flooring 309.

At least in some cases, the flooring itself includes transparent tiles or tiles that have cameras embedded therein or installed below. The floor-based cameras point upward toward the actor 306. The floor-based cameras capture at least some video information that is not capturable by side-mounted cameras in the carts. For instance, the floor-based cameras may capture video of the underside of the actor's face, or the underside of the actor's arms, or views of the bottom of the actor's shoes when walking. Thus, for example, in cases where the video data captured by the cameras is implemented to create a 3D moving model of the actor 306 as the actor moves about the enclosed flooring space, the video feeds from the floor-based cameras fill in information that is not capturable by the side-mounted cameras in the carts.

Moreover, the system 300 also includes overhead ceiling-mounted cameras. These overhead cameras (e.g., 303, 308) are also configured to track the actor 306 or other entity within the flooring area. The overhead cameras may capture video information that is not capturable by the side-mounted cameras in the carts. For instance, the overhead cameras (e.g., 303) capture the top of the user's head, the top of the user's shoulders, the top of the user's shoes, or other areas that may not be recorded or are only tangentially recorded by the side-mounted or floor-mounted cameras. These overhead cameras are individually controllable or are controlled as a group to follow or track the actor 306 as the actor moves around the flooring 309. In some cases, the video feeds from the side-mounted cameras in the carts (e.g., 302), the video feeds from the overhead cameras (e.g., 308), and/or the video feeds from the floor-based cameras (e.g., 307) are combined or stitched together to provide high-resolution representations of the actor 306 from a variety of angles and, indeed, in some cases, from a 360-degree perspective.

Thus, as the user moves around the space defined by the carts, the actor 306 may be recorded by many tens, hundreds, or thousands of cameras, some of which will be further from the actor and some of which will be closer to the actor. Those cameras that are closest to the actor 306, as the actor walks around, are used to capture the highest resolution representations of the actor 306, while those cameras that are further away are used to provide details for clothing, objects, or other items that are relevant to the actor or are relevant to what the actor is doing. In some cases, those cameras that are further away are configured to record the actor's interactions with an object of interest or are configured to record another actor or actress with whom the actor 306 is interacting. In this manner, the system 300 may dynamically shift between different cameras to ensure that at least one or at least a plurality of cameras closest to the actor are providing a high-definition video feed of the user's face or other features designated as being important to capture.

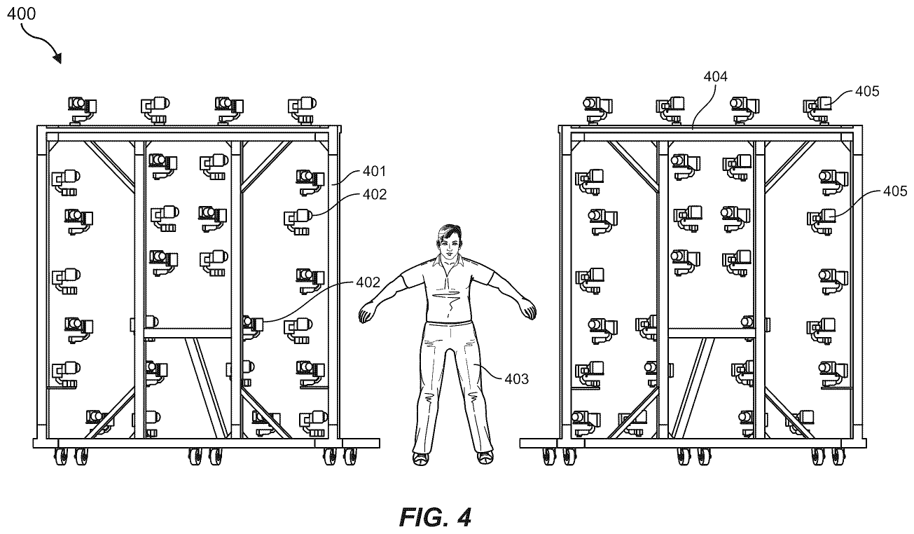

FIG. 4 illustrates an embodiment of a system 400 for capturing video. As shown in FIG. 1, a system for capturing video includes multiple carts positioned substantially equilaterally around the user. In other cases, however, the number of carts may be much smaller. In some embodiments, for instance, the video capturing system 400 may include only two carts or two support structures that have cameras attached thereto. The system in FIG. 4 includes cart 401 having cameras 402 pointed at the actor 403, as well as cart 404 having cameras 405. Each of these two carts includes 28 cameras, although more or fewer cameras may be used in each cart. The two carts are positioned toward a defined space in which the actor can perform. During the actor's performance, the cameras in those two carts (401 and 404) capture as much of the actor 403 on video as possible.

In some cases, the carts 401 and 404 are positioned next to each other (as shown in FIG. 4), while in other cases, the carts 401 and 404 are positioned at an angle toward each other or are positioned on opposite sides of each other, such that one cart is positioned to film the front of the actor 403 and another cart is positioned to video the back of the actor. Other placement variations of the two carts may also be used. In some cases, these two carts are used in conjunction with one or more overhead cameras and/or one or more floor-based cameras. This two-cart system is cheaper to rent or purchase than a 10-cart system and may be sufficient for some filmmakers' needs. In other cases, filmmakers may want to use 10, 20, or even more carts to capture multiple different actors or objects that are interacting at the same time. At least in some cases, carts are added to or removed from a video capturing system as needed. The controller for the video capture system may detect or may be notified of the existence of a new cart or of the removal of a cart and may alter its control signals accordingly.

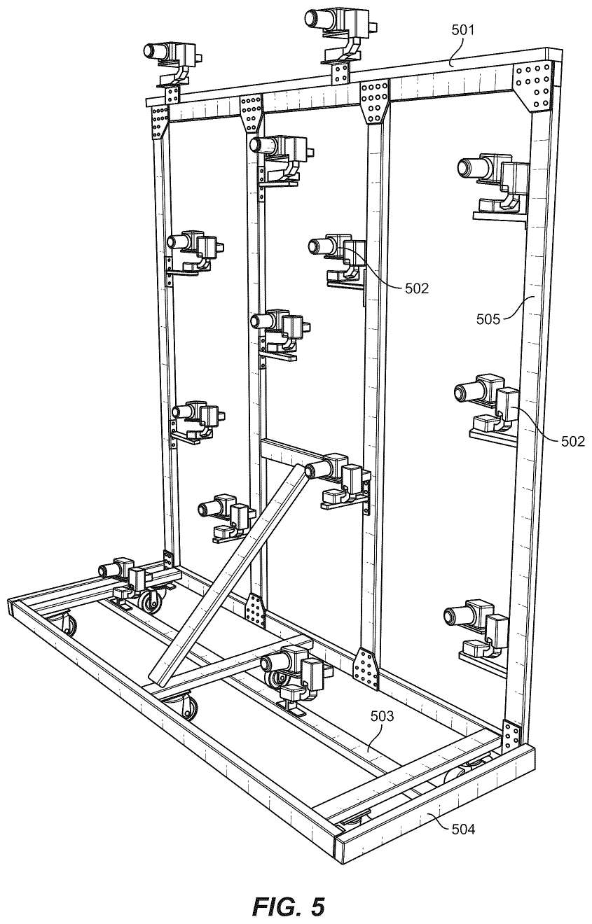

FIG. 5 illustrates an embodiment of a cart 501 in which background panels have been removed. The frame of the cart 501 includes a horizontal portion 503 structurally attached to a vertical portion 505. In this embodiment, the vertical portion houses 12 cameras 502 staggered at various levels. The horizontal portion 503 houses two cameras 504. Each of these cameras is connected to a controller via a wired or wireless connection. The controller operates each of the cameras on the horizontal and vertical portions based on their position in the cart and based on their current operational settings.

In this example, the cameras 504 on the horizontal portion 503 are closer to the actor (not shown) than the cameras 502 on the vertical portion 505. As such, the controller takes this distance into account and adjusts the zoom level, tilt, pan, focal point, or other operational settings of the cameras based on this difference in distance. Accordingly, the position of the cart 501, the position of the cameras in the cart, and other positional factors may be implemented when determining which control signals to send to each of the various cameras in the cart.

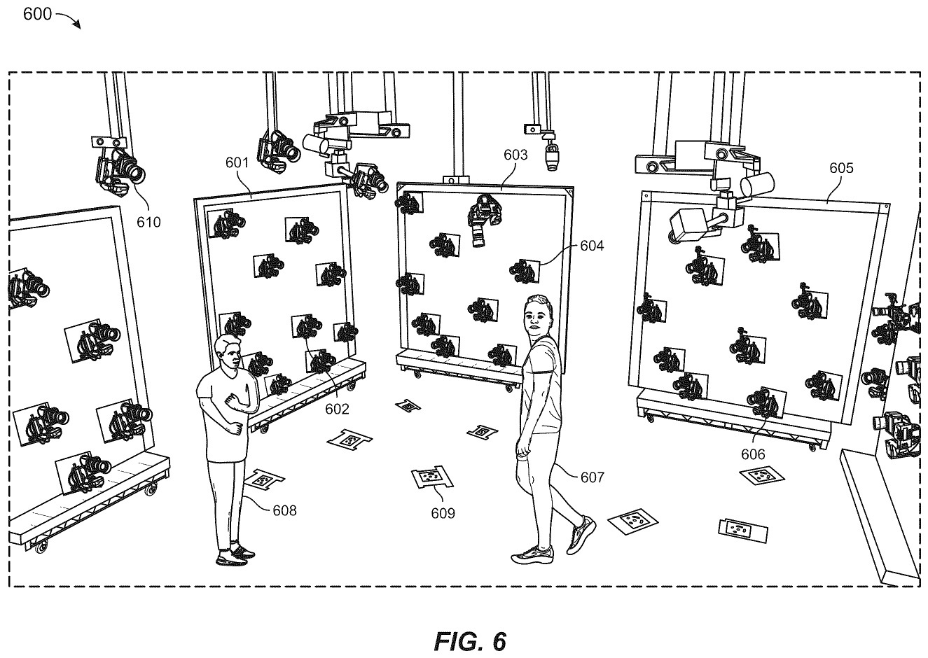

FIG. 6 illustrates an embodiment of a video capture system 600 in which two actors (607 & 608) are being recorded. At least in some cases, the video capture system 600 is configured to track two different users within a defined space 609 that lies within the perimeter formed by the carts (e.g., 601, 603, 605, etc.). In some cases, the actors are wearing a physical emblem, marker, sticker, or other item that is recognizable by the cameras (or by logic in the cameras processing the video feed). In other cases, the actors are wearing radio frequency identifier (RFID) tags, infrared light sources, or other invisible (but detectable and potentially unique) markers.

Using these identifiers, at least a portion of the cameras (e.g., 602, 604, 606, etc.) will track the actors 607 and/or 608 as they move within the defined perimeter. In some cases, half of the cameras (e.g., one on each row of the surrounding carts, where each row has two cameras) or some other percentage of the cameras are assigned to follow one of the actors, while the other half of the cameras (or other arbitrary percentage) are assigned to follow the other actor. Thus, as the actors move within the defined space 609, the actors' facial expressions, actions, movements, sounds, and other data are captured by the video capture system 600.

Additionally, in some cases, the video capture system 600 includes overhead cameras and/or floor-based cameras. The overhead cameras 610 may similarly be controlled to track the movements or other actions of the actors 607 and/or 608. The overhead cameras 610 may capture additional details that are not captured or are only obliquely captured by the cameras in the surrounding carts (e.g., 601, 603, 605, etc.). As with the cameras in the carts, the overhead cameras 610 may be similarly divided into groups, where one group is following actor 607 and the other group is following actor 608. In cases where multiple actors (3+) are being tracked in the defined space 609, the cameras may similarly be divided into 3+ groups to track each of the actors or actresses separately.

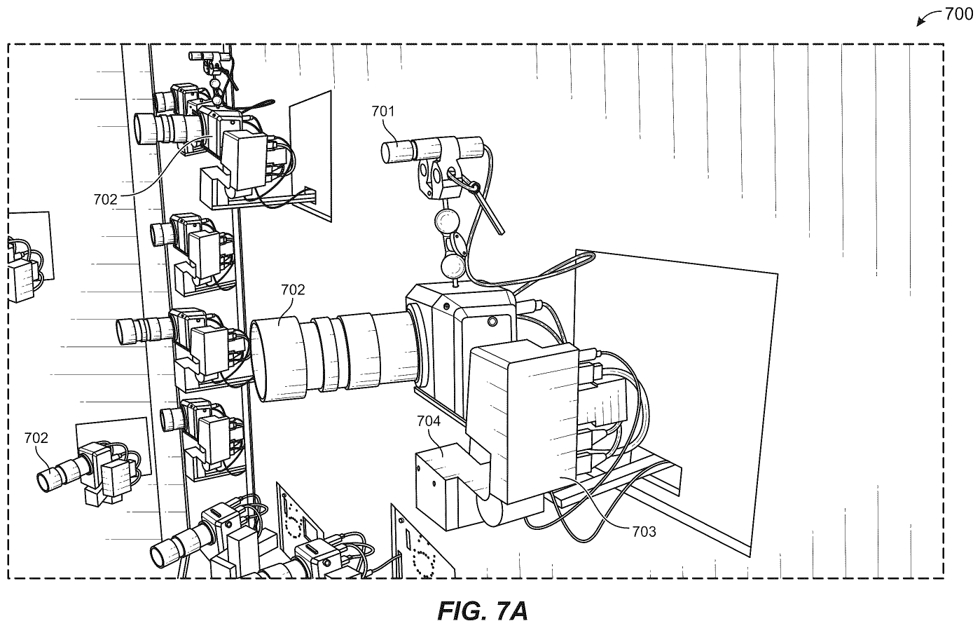

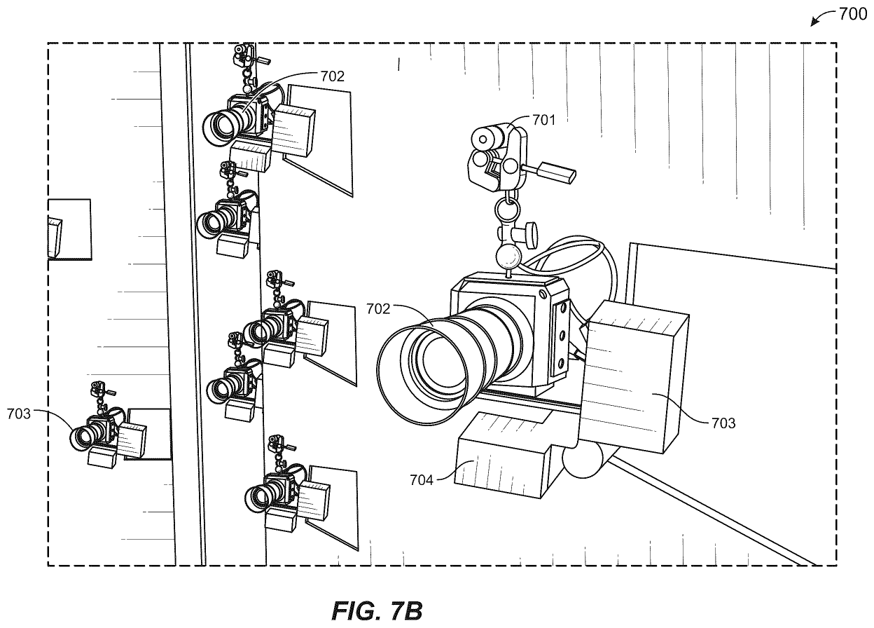

FIG. 7A illustrates a close-up view of a video capturing system 700 that includes multiple cameras 702 positioned at different heights, different widths, and potentially different depths. Each camera may be configured to film in 4k, 8k, or some other higher or lower resolution, and each camera may operate at 24 frames per second (FPS) or at some other selectable frame rate. The cameras 702 may be mounted on gimbals 704 or on other support structures that allow movement (e.g., pan, tilt, zoom, etc.). Some or all of the cameras may also have lasers or infrared devices 701. These lasers may be configured to shine on the entity, reflect off of the entity, and be detected by one or more light sensors near the lasers or infrared devices 701. The lasers or infrared devices 701 may provide additional details about the entity, including wardrobe details, skin details, or other entity-related details.

In some cases, for instance, when an actress is wearing a black shirt or black pants, the visible light captured by the cameras may not provide a lot of information about how the fabric is folding, stretching, bunching, or moving. The lasers or infrared devices 701 may detect infrared or laser light that is shined at and reflected off of the entity (or entities). This infrared light sensor and/or laser light sensor thus provides additional details (additional to visible light) that can be used when generating a 3D model of the entity or when generating a high-resolution representation of the entity. The additional light may provide details that would not be available through visible light alone. The lasers, infrared light sources, light sensors, and cameras 702 may move in tandem (as shown in the positional differences between the cameras in FIGS. 7A and 7B) to follow the entity as it moves within the defined space.

In some cases, the cameras may have associated processing units 703. The processing units may analyze video feeds, encode or decode video frames, identify entities in the defined space, track the entities within the defined space, add the laser and/or infrared light information to the video feed, communicate with a system controller (which may be separate from or part of the processing unit 703), store some or all of the video feed or additional light information, or perform other functions related to the capturing of video.

FIG. 8 illustrates an embodiment in which a video capturing system includes one or more modular flooring elements. The modular flooring elements (e.g., 801) may include a substructure designed to handle the weight of actors and/or other entities on top of it. The substructure may also be designed to handle the weight of carts, the weight ceiling trusses, or other items that may be placed on the modular flooring elements 801. In some cases, the modular flooring elements may include various grippy tiles 802 that provide additional grip for the actors' feet. The grippy tiles 802 may also have markers 805 on them to guide the movement of the side cameras and overhead cameras. The modular flooring elements may also include tiles having transparent material 803. The transparent material 803 may allow light to reach one or more cameras that are installed underneath the portion of transparent material.

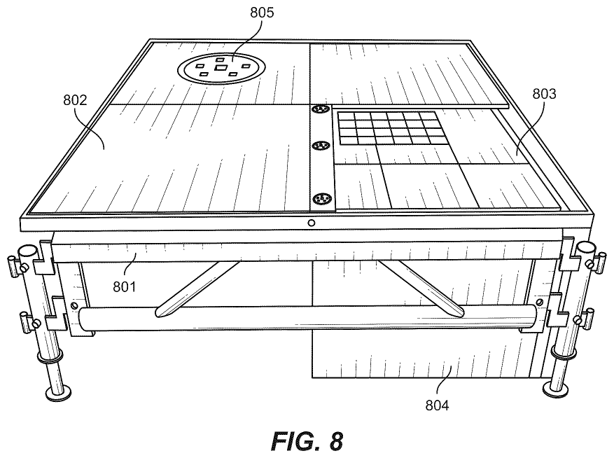

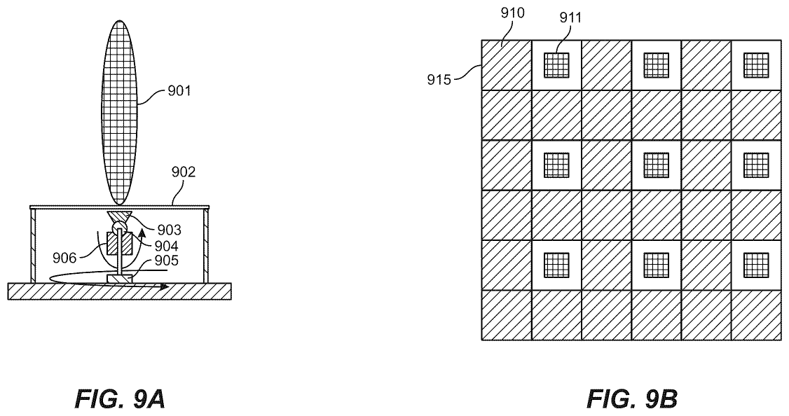

As shown in FIG. 9A, the camera(s) 906 underneath the transparent material 902 in the modular flooring element may be configured to pivot from a central axis 904 to maintain focus on the specified entity or entities (e.g., 901). In some cases, the central axis 904 is a robotic axis that can rotate the camera 906 along a specified axis. A second robotic axis 905 may be configured to rotate the camera 906 along an opposite axis. Either or both of these axes may be controlled via control signals from a controller. Moreover, a motorized zoom and focus lens 903 (which may be similar to or the same as the motorized lens 1206 of FIG. 12) may also be implemented to control the amount of zoom and control the focus of the lens.

In some examples, a floor upon which the actors perform may be composed entirely of such modular flooring elements 801. In other cases, the floor may include portions that have modular flooring elements, and portions that do not. For instance, as shown in FIG. 9B, a floor 915 may include multiple solid modules 910 that have structured textures or specific tag patterns. Other portions of the floor 915 have glass modules with cameras 911 below the glass. Each camera 906 that is mounted in a modular flooring element 801 may be configured to track the movements of the actor. In addition to control signals for horizontally-mounted and overhead-mounted cameras, the controller may additionally generate and send control signals to the camera 804/906 underneath the various portions of transparent material in the various modular flooring elements to track the actor or other specified entity 901 as the entity moves across the floor within the defined space.

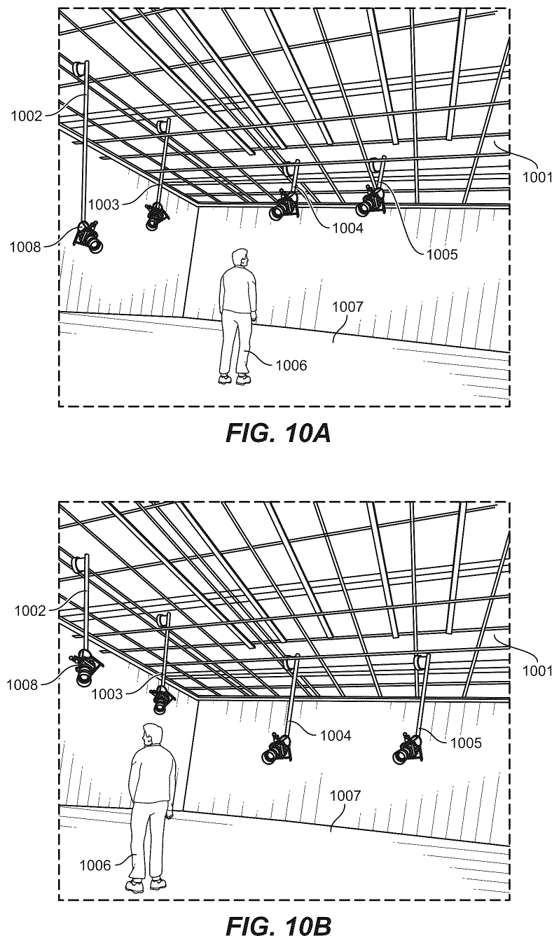

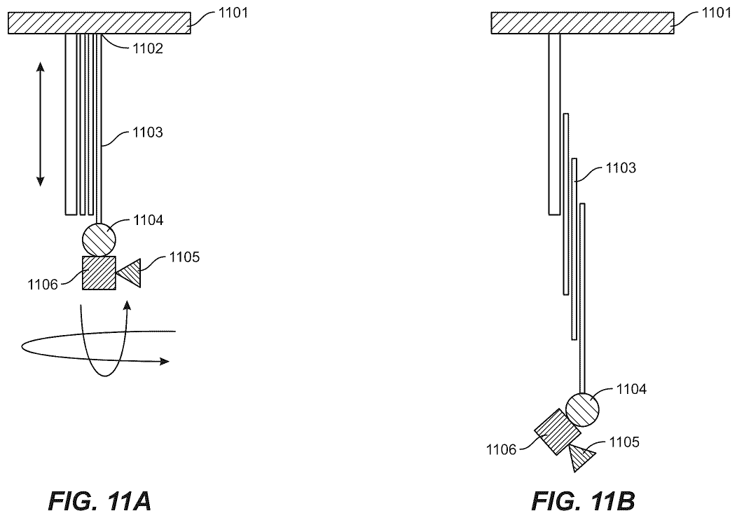

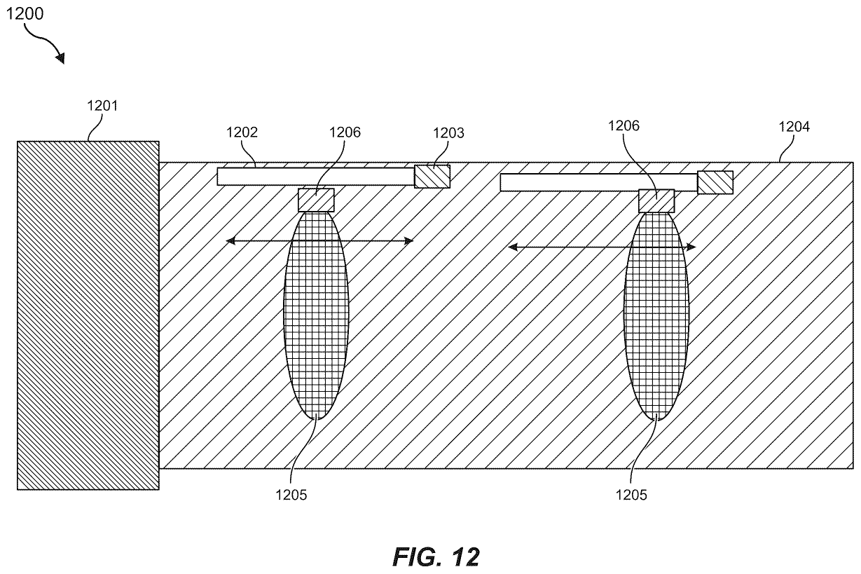

FIG. 10A illustrates a dynamic ceiling 1000. The dynamic ceiling 1000 includes one or more different dynamic ceiling elements 1001-1005 that are part of the dynamic ceiling 1001. In some cases, the dynamic ceiling elements include structural components, such as a telescoping pole, as well as a controllably moveable camera 1008 mounted thereto. The telescoping pole (e.g., 1103 of FIG. 11A) may be configured to telescope upward or downward relative to the dynamic ceiling. This allows the cameras mounted to the telescoping poles to be lowered down closer to the actresses or retracted back upward away from the actresses or other entities. The dynamic ceiling may include 10, 20, 50, 100, or substantially any number of dynamic ceiling elements having cameras affixed thereto. These dynamic ceiling elements work in unison to follow an actress or multiple actresses as they move within a defined space.

Cameras that are attached to telescoping poles that are approximately 20′ from the actress may telescope down to roughly face level (or to some other predefined height relative to the actress or other entity). As the actress moves around the defined area, she may move closer to some cameras and away from others. Those that are too close to the actress (e.g., within 5′ or less) may be retracted and moved out of the way. Other cameras that were previously too close to the actress may dynamically telescope downward to capture the actress' face, hands, or other specific features. For example, as shown in FIG. 10A an actress 1006 may begin performing on the left side of a defined area 1007. In this initial position, the cameras on the left side may be in a retracted state or semi-retracted state (e.g., dynamic ceiling elements 1002 and 1003). During her acting, the actress 1006 may move to the right side of the defined area 1007, as shown in FIG. 10B. As the actress moves, the telescoping dynamic ceiling elements 1004 and 1004 may retract upwards toward the ceiling 1001, while the other dynamic ceiling elements 1002 and 1003 may lower back downwards.

In this manner, the telescoping poles of the dynamic ceiling 1000 move upward and downward as the actress moves closer and away from the cameras, ensuring that the cameras that are best positioned to capture the actress (e.g., positioned 10′-20′ away) are lowered to her height, while cameras that are too close (e.g., to where the actress' movement would be impaired) are dynamically moved out of the way to an overhead position. The video capture system's controller may determine, based on the current, tracked position of the actress, which cameras to dynamically lower and which cameras to raise, in response to the actress' movements.

The controller may also control the tilt, pan, zoom, or other features of the camera (e.g., 1008) based on the current telescoped or withdrawn position on the telescoping pole 1002 by sending control signals to servo motors or other actuators within the cameras. In some cases, the telescoping, dynamic ceiling poles may include vertical actuators that activate the telescoping mechanism upon receiving a specific control signal from the controller. When such a signal is received, the vertical actuators actuate the mechanical motion that retracts or extends the telescoping poles.

For example, as shown in FIGS. 11A and 11B, a vertical actuator 1102 may be mounted to a ceiling 1101 (e.g., dynamic ceiling 1000 of FIG. 10A). The vertical actuator 1102 may include a set of rails 1103 that can slide against each other in a telescoping manner. The vertical actuator 1102 further includes a robotic unit 1104 that can pan and tilt the camera 1106 in substantially any direction. The vertical actuator 1102 further includes a motorized zoom and focus lens 1105 that allows the camera to be refocused as the actress moves around the defined space. As shown in FIG. 11B, the set of rails 1103 may be partially or fully extended, and the camera 1106 may be panned and/or tilted into a position that tracks the movements of the actress. Still further, the controller may take into account the continually changing position of the camera and the retracted or extended poles when generating control signals for the cameras in the dynamic ceiling (and in the flooring and sides).

At least in some cases, the control signals may actuate motorized lenses within the cameras. As shown in FIG. 12, these motorized zoom lenses may include multiple individual optical elements. To keep an actress or other entity visible at the same size, elements that create zoom need to be moved, as well as elements that control focus (or a combination thereof). In at least some embodiments, the amount of lens movement is calculated by a processor or controller that tracks the position of the actress in space. Based on the distance to the camera body 1201, the processor calculates which zoom value would create the appropriate size in frame and calculates which focus value is needed to create a sharp image. The motorized lens 1200 of FIG. 12 may include an outer camera body 1201, a spiral rail element 1202, and a motor 1203 that moves a lens 1206 along the axis of the spiral rail element 1202 within a lens chassis 1204. The motorized lens 1200 may ensure that the lens 1206 focuses the subject 1205, even as the lens moves along the spiral rail element 1202.

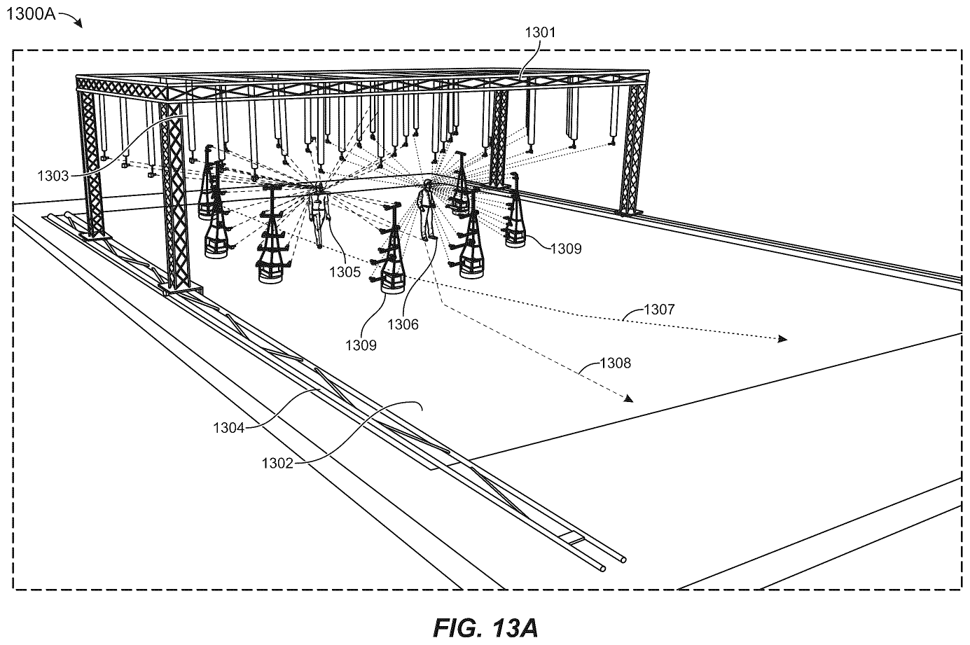

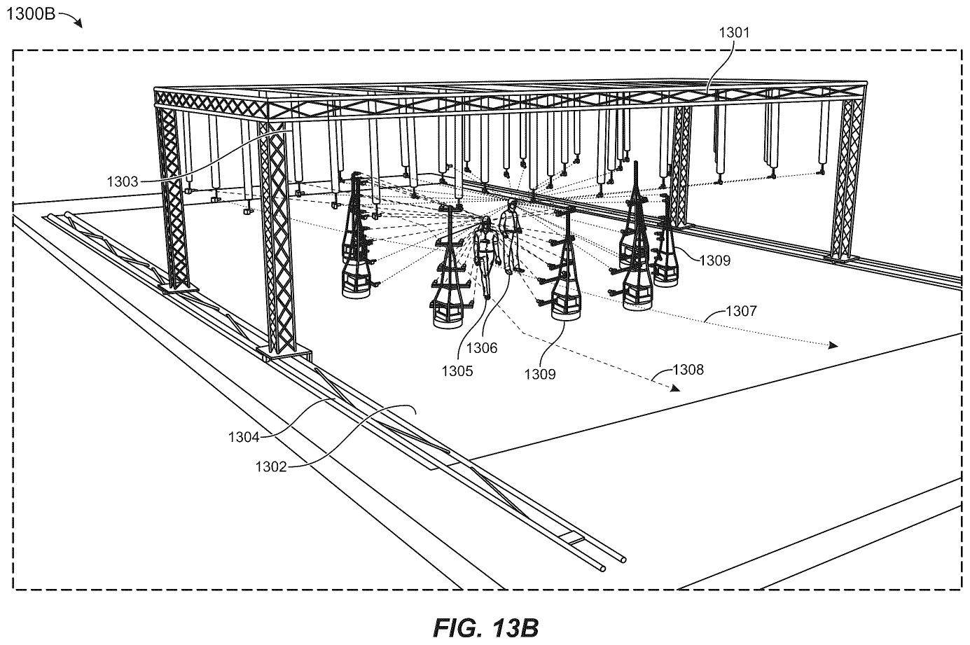

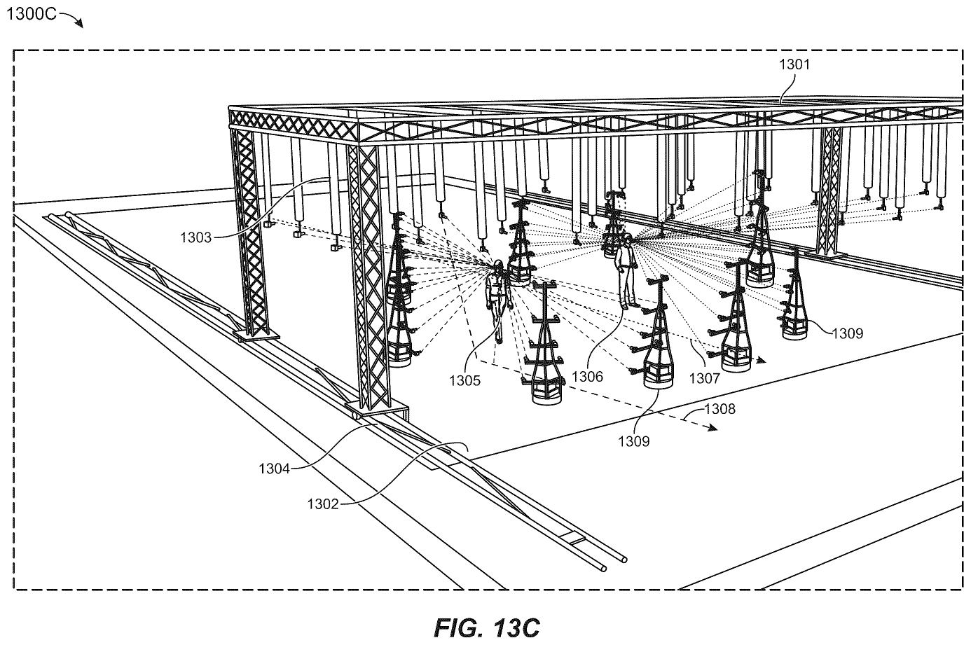

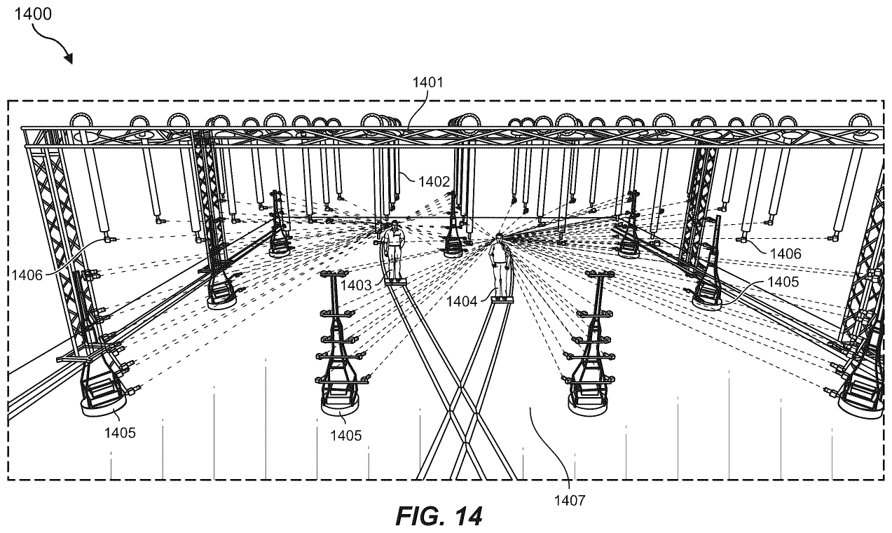

In this manner, the motorized lens 1200 of FIG. 12 may assist in focusing the cameras on the subject 1205 in a more controlled and reliable manner. The motorized zoom lens 1200 may be implemented in some or all of the cameras in the video capture systems described herein. These motorized zoom lenses may also be used in the mobile video capturing system described in FIGS. 13A-14 below.

FIGS. 13A-13C illustrate an embodiment 1300A of a video capture device that is configured to move with the entities as they walk, run, converse, fight, play sports, or otherwise interact with each other. As in the embodiments above, the entities may be actors or actresses that are being filmed as part of a movie or television show. In some cases, it may be desirable to allow those actors, actresses, or other objects (e.g., vehicles) to move freely while performing actions that are pertinent to the movie or tv show. This may allow the entities to behave more naturally while performing their roles in the movie or tv show.

Thus, in some cases, a video capture system may be provided that is mobile. The mobility may be semi-constrained (e.g., the support structure may move on rails or within a specified space) or may be entirely free to move where desired. In some cases, one or more of the cameras in the mobile video capture system may be mounted to mobile robots, drones, or other controllable, mobile devices. The mobile robots may be programmed to track the entities using any of the methods described above and may be configured to remain within a specified distance of specific entities to capture those entities' movements on video.

In some cases, a support structure 1301 is provided which includes four stands, and each of these stands may be attached to rails 1304. The support structure holds multiple ceiling cameras 1303 (e.g., 10, 20, 50, 100, or more) that move along with the actors 1305 and 1306. The support structure 1301 moves along the rails 1304 as the actors 1305 and 1306 move and converse or perform other actions. The movement of the support structure 1301 may be controlled by a controller that receives sensor inputs from motion sensors, position sensors, video cameras, or other sensors that indicate movement and position of the support structure 1301.

The controller may then send control signals to motors that are configured to propel the support structure 1301 along the rails 1304, including stopping or reversing motion. Thus, actors or actresses may be free to move within the space 1302 defined by the outer rails. In some cases, the overhead cameras 1303 may be affixed to drones and, in such cases, the rail-based support structure 1301 may not be needed, allowing further freedom of movement to the actors and actresses.

In some cases, the mobile video capture system of FIGS. 13A-13C may include mobile robots 1309 that have cameras affixed to them. These dynamic robotic volumetric capture robots (or drones) may perform preprogrammed moves to capture the entities or may dynamically adjust their position and orientation based on the actions or responses of the entities. Thus, whether the robots 1309 are wheeled or are capable of flying, the robots may surround the entities to capture their movements and actions on video. The video capture may be synchronous and controlled across the various robots 1309.

Thus, a controller may send control signals to the various robots 1309 to remain in a circle around the entities (or remain in some other shape near the entities) as the entities move. To generate these control signals, the controller may rely on positional input received from the entities 1305/1306, from the support structure 1301, and from the mobile robots 1309. Thus, knowing where the entities currently are and what their current trajectory is, the controller may move the support structure 1301 and/or the mobile robots 1309 to follow the movements of the entities 1305/1306.

In some cases, the entities may have a prescribed path of movement. For instance, in FIG. 13A, actor 1305 may move along path 1307 and actor 1306 may move along path 1308. The ceiling grid of cameras 1303 that are attached to the support structure 1301 may then move along with the actors as they move along their scripted paths. As such, the ceiling grid of cameras may move along one axis, as part of the support structure 1301, to follow the action of the actors. In some cases, the ceiling grid structure may be 40′×60′ feet wide but may be larger or smaller as needed. Movement of the support structure 1301 and the ceiling grid of cameras 1303 may be motorized and on rails 1304 and may be configured to automatically recenter itself over the actors' actions. In this manner, a long walk and talk, a fight scene, or other interaction may be closely followed by the video capture system as the action occurs.

While the embodiments 1300A, 1300B, and 1300C of FIGS. 13A-13C show nine moveable robots, it will be understood that substantially any number of such robots may be used. These robots may be fully autonomous, using a plurality of position and visual sensors to follow the actors as they move. Because the video capture system tracks the position of the actors (using any of the tracking methods described above), the video capture system can compute the optimal positions for the cameras around those actors. In some cases, the robots may be arranged and continually controlled to provide 12 camera angles equally angularly distributed around the entities in approximately 30-degree angles.

In the embodiments herein, the robots 1309 may include mounted tripod structures that can each hold a variety of camera image sensors. The robots 1309 may be able to rotate and drive omnidirectionally around the defined space 1302 and may continually optimize their position and angle to follow the actors' actions. In some cases, the robots may be configured to stay approximately 20 feet away from the actors to not disrupt their performance, while being close enough to capture high resolution footage. The robots may also be programmed to avoid obstacles and to emergency stop upon getting too close to entities or other objects. Such a video capture stage provides versatility and may provide multiple different capabilities including being much larger than other video capture areas, providing support for long, continuous actions that span a large area, allowing any shape of action from the entity and allowing the shape of the action to change dynamically, and providing a portable video capture area that can be deployed substantially anywhere in the world.

FIGS. 13A-13C illustrate a progression in which the robots 1309 and the support structure 1301 are directed, by a controller, to follow and maintain a specified distance away from the specified entity or group of entities. The robots 1309 may be controlled independently or in conjunction with the support structure 1301. As the actors 1305 and 1306 walk down the paths 1307 and 1308 (which may be predetermined or may reflect the paths that were ultimately taken by the actors, after the fact). The robots 1309 and support structure 1301 may aim to stay within 10′-20′ feet of the actresses (or some other prescribed distance).

In some cases, the robots 1309 and support structure may be more or less lenient when maintaining this following (or leading) distance. The robots may be configured to track their own position in space, independently of the other robots, and/or may be able to determine their position relative to the other robots and/or the entities. The determination of a current, real-time or relative position may be determined using any of the methods described above, including video image analysis, GPS coordinates obtained from GPS satellites, wireless intercommunications between devices (e.g., Bluetooth, WiFi), radar signals from surrounding objects, or other position sensing methods.

In some cases, the ceiling of the support structure 1301 may be a static ceiling, with cameras being attached to static poles or other static structural elements. In other cases, the ceiling of the support structure 1301 may be a dynamic ceiling, with cameras 1303 being attached to dynamically extendable or retractable telescoping poles. The poles may be configured to lower down or raise upward to get a better, more up-close shot, or to move out of the actress' way. Thus, the mobile support structure 1301, the mobile robots 1309, and the dynamic ceiling may operate in conjunction to capture specified entities from a variety of different angles and at distances that optimize for high fidelity and clear picture (e.g., avoiding or reducing shots from cameras that are too far away or are too close to the actresses. These optimizations may provide the incoming light needed to provide high quality video feeds. Such high-quality video feeds can then be implemented directly in films and tv shows, as well as in the creation of three-dimensional models of the actresses or other entities.

FIG. 14 illustrates an embodiment of a mobile video capturing system 1400. Like the mobile video capturing system 1300A, the mobile video capturing system 1400 may include a support structure 1401 that may be positioned on wheels or on a rail system. While the rail system will guide the support structure 1401 along a specified path, a wheeled support structure would allow the support structure to travel in substantial any direction. The support structure 1401 may include a static ceiling or a dynamic ceiling or a combination thereof that includes both static poles or telescoping poles 1402. The telescoping poles may add flexibility and more dynamic coverage of the entity being captured.

FIG. 14 illustrates multiple lines of sight from the overhead cameras 1406 on the static or dynamic ceiling to the actors 1403 and 1404. These lines of sight indicate the number of cameras (and potentially other devices, such as lasers, infrared sensors, etc.) that can observe the actors 1403/1404. Thus, in the embodiment of FIG. 14, the mobile video capturing system 1400 may have many different cameras pointing at the actors from a variety of overhead, side, and potentially underneath views.

FIG. 14 further illustrates a plurality of mobile robots 1405 (or potentially flying drones) that are controlled individually or via a central controller. The robots may be configured to remain within a defined area 1407, in some cases, while being allowed free range of movement in other cases. A central controller may track the current location of each robot 1405 and may control each robots' movements to maintain a specified distance away from the entities being captured on video. Each of the robots 1405 may provide a support structure configured to hold multiple different cameras. The lines of sight between the cameras and the actors 1403/1404 indicate how many different cameras are capturing video of the actors 1403/1404.

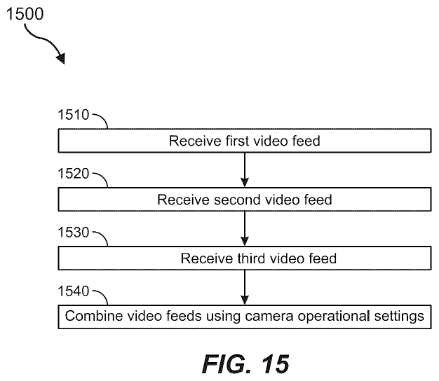

Each camera may have its own operational settings. These operational settings may indicate, at each moment, how the camera is operating (e.g., zoom level, angle of pan or tilt, frame capture rate, light level, f-stop, aperture, lens type, data storage rate, data transmission rate, etc.). Any or all of this information may be stored at the camera or at the robot on internal storage or may be transmitted wirelessly to cloud or other remote data storage. This information, including an indication of which entity is being tracked by that camera, may be stored as metadata. This metadata may then be used to combine video feeds. In some cases, the highest quality feeds from different cameras may be stitched together to provide an ultra-high-quality representation of the entities and their actions. This process will be described further below with regard to method 1500 of FIG. 15.

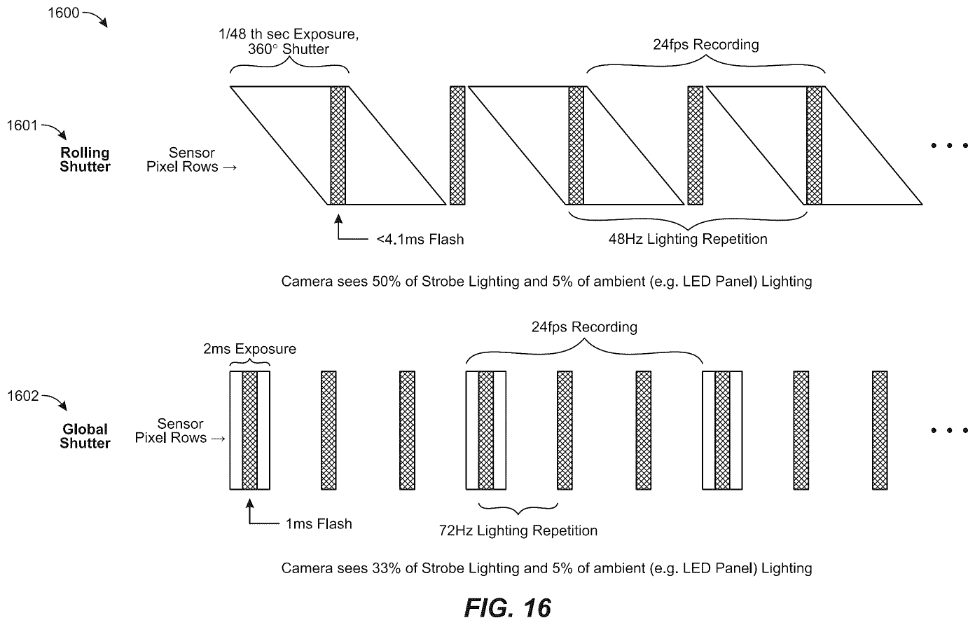

FIG. 15 is a flow diagram of an exemplary computer-implemented method 1500 for combining video feeds from a plurality of cameras using different operational settings. The steps shown in FIG. 15 may be performed by any suitable computer-executable code and/or computing system, including the systems illustrated in FIGS. 16, 17, and 18. In one example, each of the steps shown in FIG. 15 may represent an algorithm whose structure includes and/or is represented by multiple sub-steps, examples of which will be provided in greater detail below.

Method 1500 includes, at 1510, a step for receiving a first video feed from a first plurality of cameras mounted in a first structure, where each camera is controllably moveable in synchronization with a second plurality of cameras on a second structure and with a third plurality of cameras on a third, overhead structure. The first, second, and third pluralities of cameras are controllably directed toward at least one specified entity, and the first video feed includes first metadata comprising dynamically updated camera operating information for the first plurality of cameras. At step 1520, method 1500 includes receiving a second video feed from the second plurality of cameras, where each camera is controllably moveable in synchronization with the first and third pluralities of cameras, and where the second video feed includes second metadata comprising dynamically updated camera operating information for the second plurality of cameras.

Method 1500 next includes, at step 1530, receiving a third video feed from the third plurality of cameras, where each camera is controllably moveable in synchronization with the first and second pluralities of cameras, and where the third video feed includes third metadata comprising dynamically updated camera operating information for the third plurality of cameras. At step 1540, the method 1500 includes combining, using the first, second, and third metadata, at least a portion of the first video feed, the second video feed, and the third video feed into a single video feed that tracks the specified entity as the specified entity moves within a defined space that is observable by the first, second, and third pluralities of cameras.

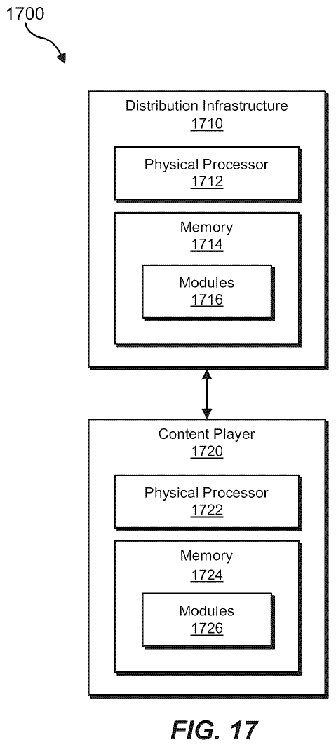

The steps of method 1500 may be carried out on substantially any type of computer system using any combination of computer hardware, software or firmware. In some cases, a distribution infrastructure (e.g., 1710 of FIG. 17) may be implemented to receive metadata, process the metadata, and combine video feeds, as will be further described below. A suitable computer system may include various electronic components and elements that are used, alone or in combination with other computer systems, to perform specified tasks. The computer system may be substantially any type of computer system including a local computer system or a distributed (e.g., cloud) computer system. The computer system includes at least one physical processor 1712 and at least some system memory 1714. The computer system includes program modules 1716 for performing a variety of different functions. The program modules may be hardware-based, software-based, or may include a combination of hardware and software. Each program module uses computing hardware and/or software to perform specified functions, including those described herein below.

At least in some embodiments, the computer systems and processors described herein are configured to stitch or combine video feeds together from the multiple cameras into a combined video feed. Additionally or alternatively, the video feeds from the various cameras may be combined together to create a three-dimensional model of the entity or entities that are being captured on video. As noted above, and as shown in FIG. 14, a video capture system, whether mobile or stationary, may include overhead cameras, side-mounted cameras, and/or floor-mounted cameras. These cameras may be directed toward the entities that are being filmed (e.g., 1403 and 1404).

Each camera is positioned at a different angle, whether that difference in angle is great or small. Moreover, each camera may be operating with a different level of zoom, each camera may be positioned at a different height or angle to the entities, each camera may be operating at a (slightly) different level of tilt or pan, some cameras may be operating at different resolutions or different frame rates, some cameras may be operating at different focal ratios or may have different types of lenses (e.g., motorized or non-motorized, made of different materials, etc., or may be operating using different settings than other cameras. Each of these operational settings may also be changed over time as the position of the video capture system changes or as the position of the robots change or as carts are repositioned on a stage or platform.

At least in some embodiments, the operational settings for each camera may be stored, either locally at the camera in internal storage, or externally in a remote data store. The operational settings may be continually changing and may be continually updated. Moreover, the operational settings may be time synchronized to the video feeds from each camera. Thus, at any given point in the video feed from a camera, the operational settings (stored in metadata) may indicate that camera's angle of operation, zoom level, pan level, tilt level, focal ratio, and other operational settings.

This operational settings data for the various cameras may be gathered and stored, along with the video feeds from each of the cameras, in a central database, either locally or remotely. This database may then have not only the video feed data from tens, hundreds, or thousands of cameras, but also the operational information for each camera and each moment of recorded footage. The operational settings data may indicate which specific camera captured the video feed, which entity the camera was following or tracking, and which operational settings were being used at each point in the video capture. This information may then be used to create a combined video feed and/or a 3D model of entities being captured on video.

At least in some cases, the process of combining the various tens, hundreds, or thousands of video feeds may include removing at least some of the video feed data from some or all of the various video feeds. The amount of data from high numbers of video feeds may be very large, and some of that data may be more pertinent or valuable than other data. For instance, if a filmmaker wants a close-up shot of an actress' face for a dramatic moment in a movie, those video cameras that are optimally positioned to capture the actress' face at that moment in time may be identified.

Moreover, those cameras that are using an optimal zoom value, an optimal focal ratio, tilt or pan level, etc. may be identified from the various video feeds. Other operational settings may be used to sort through and identify the optimal video feeds for that specific scene or shot. The video data from those feeds may be prioritized over other video data from other feeds. Thus, some or all of the video data from video cameras that are identified as optimal for that scene may be stored, while other video data is not used, is minimized, or is discarded. In some cases, the best video data showing the clearest images with the highest resolution and fidelity may be stored and combined, while other video image data is removed. Even within a single video feed, some of the data may be more relevant (the video data capturing the actress' face) than other data.

Thus, the systems herein may determine, using machine learning algorithms or other learning tools, which information is most pertinent for a given scene or shot. The level of pertinence may depend on context (e.g., is it a battle scene, a car chase, a dialogue scene, an emotional scene, etc.). The level of pertinence may depend on which entities the cameras were focused on (e.g., major characters vs. minor characters, objects of high importance (e.g., a ring or a key or a photograph, etc.), background scenery that may be important to a shot or scene, etc. Thus, the systems herein may be configured to analyze the video feed data from the overhead, side-mounted, and/or floor-mounted cameras, determine which video data is most important to preserve, and then remove data that is not needed for that scene or shot.

In some cases, a filmmaker may specify which entities are to be the focus of the scene, whether the entities are actors or objects. For example, in a scene shot using the mobile video capture system 1400 in FIG. 14, the filmmaker may identify the actors 1403 and 1404 as being two entities that are to be captured and that each is of equal importance. The mobile video capture system 1400 may then initialize recording and, upon completing recording, may identify which video frames from each video feed include the actors 1403 and 1404.

At least in some cases, video frames that include the specified entity or entities may include determining whether the video frames from a given video feed have a minimum threshold amount of the specified entity in the video frame. For example, video frames in which the specified entity fills at least 40% of the frame, 50% of the frame, 60%, 70%, or some other configurable percentage may qualify as having the minimum threshold amount of the specified entity in the frame. Those video frames that have the minimum threshold amount of the specified entity are selected for use in the combined video feed and/or 3D model of the entity.

Additionally or alternatively, identifying which video frames from each video feed include the specified entity may include determining whether the video frames include the specified entity at a minimum threshold quality level. For example, video frames in which the specified entity is in the shot and in which the quality of the frame is sufficiently clear (i.e., not blurry), sufficiently focused, sufficiently lit, sufficiently zoomed, etc. or meet some other measure of quality may be said to meet the minimum quality threshold and may be selected for use in the combined video feed and/or 3D model of the entity. Other video feeds or other images from the same feed may be removed and stored for later consumption or may be discarded.

Similarly, identifying which video frames from each video feed include the specified entity may include determining whether the video frames include the specified entity at a specified angle. For instance, in some shots or scenes, a filmmaker may want to focus on direct, straight shots of the entity. In other cases, the filmmaker may want to focus on side shots, overhead shots, underneath shots, or shots taken at a specific angle. The filmmaker may then specify this angle or shot type, and the video capture system may determine, based on the stored operational settings for the cameras, which cameras were shooting the entity at the specified angle or with the specified shot type. Those video feeds may then be selected for inclusion in a combined video feed and/or 3D model.

The computer system may then combine the selected video feeds into a combined video feed or 3D model. The combination may remove redundant data and may focus on video feeds from certain cameras based on any of the criteria identified above. With the redundant data removed and the optimal video feeds identified, the computer system may then stitch together a single, combined video feed that may include video capture data from multiple different video feeds. At least in some cases, the combined video feed may focus on a specific actor, actress, or object and may include the best video data for that entity, at the angle or shot type specified by the filmmaker.

The combined video feed may use the most optimal video feeds, as determined by each camera's operational settings, as determined by the amount of the entity in the shot or the quality of the video feed or the desired shot type or other preferences. This combination of the most optimal video feeds may result in a combined video feed that highlights and clearly captures the actions, the features, and the nuances of the entity being captured. In this manner, the systems herein may allow entities to move freely within a space and may capture those entities' actions, movements, and facial expressions while they move, in a more natural and organic way.

FIG. 16 illustrates an embodiment 1600 that attempts to solve the problem of shooting short exposures to avoid motion-blurred images while keeping the total amount of light in the scene reasonable without increasing the camera gain so much that the gain produces noisy images and, thus, poor 3D reconstructions. In some cases, such embodiments may illuminate the interior of a large-scale volumetric video capture stage with precisely-synchronized, diffuse strobe lighting to reduce motion blur, eliminate rolling shutter distortions, and keep the total light on the subjects below a maximum amount. Without such strobing, implementations might need 50,000 lux on subjects in order to achieve such low motion blur; with the strobing described herein, however, these systems may implement only 72/1000's of this or 3,600 lux, which would be comfortable to the subjects being filmed.

This embodiment involves placing white surfaces around some or all of the capture system (e.g., by painting or wallpapering the walls and/or ceiling and/or floor white), and then lighting these surfaces indirectly with a plurality of light sources facing away from the cameras and toward the surfaces of the capture room. This provides diffuse, indirect light on the scene with the actors, without any of the bright light sources being seen directly in the cameras, thereby avoiding glare.

The process also involves strobing the lights at short repeating intervals (e.g., 1 millisecond pulses), synchronized to the cameras' electronic shutters to effectively freeze the subject's motion during the recording interval for each frame, while also greatly reducing the total amount of light on the subject over the course of any given period of time. In some cases, this can also be done with lights aimed directly toward the subjects, but there may be more glare in the cameras and in the eyes of the subjects.

For global shutter cameras (e.g., 1602), the lights are strobed at a rate which is a multiple of the frame rate of the cameras (e.g., strobing the lighting at 72 Hz when the cameras are recording at 24 Hz), so that the strobing lighting is above the flicker fusion rate of the human visual system (e.g., above 50 Hz), but the cameras can continue to record the action at the standard movie frame rate of 24 fps without recording extraneous data. In this case, the cameras record a frame of action during every third strobe. This also allows the recording system to mostly ignore the contribution of ambient light, which may cause motion blur smearing without the short camera shutters.

For rolling shutter cameras (e.g., 1601), the shutter angle is specifically selected and precisely synchronized so that each strobe pulses when the entire sensor is exposing. The process also includes placing the non-photographed strobes so that they occur when none of the active sensor area is exposing. The top row of FIG. 16 shows how to achieve this for a 48 Hz strobe and 24 Hz camera frame rate, which is still slightly below flicker fusion but still functional and is likely more comfortable to view than 24 Hz strobing. In some cases, the system will shorten the shutter angle to 120 degrees (e.g., exposing for ⅓ of 1/24th of a second, or 1/72th of a second) and will reduce the active pixel area to 2160 pixel rows in order to strobe at a comfortable 72 Hz and film at 24 Hz with no cross-talk of non-photographed strobe patterns into the photographed ones.

In addition to the method described above, a corresponding apparatus is also provided. The apparatus includes a first structure configured to house a first set of cameras. Each camera is controllably moveable in synchronization with a second set of cameras on a second structure and with a third set of cameras on a third, overhead structure. The first, second, and third sets of cameras are controllably directed toward at least one specified entity, such as an actor or actress. The apparatus includes the second structure which is configured to house the second set of cameras. Each of these cameras is controllably moveable in synchronization with the first and third sets of cameras. The apparatus also includes the third, overhead structure that is configured to house the third set of cameras. Each of those cameras is controllably moveable in synchronization with the first and second sets of cameras. The apparatus further includes a controller configured to generate and send control signals to the first, second, and third sets of cameras to track the specified entity as the entity moves within a defined space that is observable by the first, second, and third sets of cameras housed in the first, second, and third structures.

Furthermore, a video capture device may additionally be provided. The video capture device includes a first structure configured to house a first set of cameras. Each camera is controllably moveable in synchronization with a second set of cameras on a second structure and with a third set of cameras on a third, overhead structure. The first, second, and third sets of cameras are controllably directed toward at least one specified entity, such as an actor or actress. The video capture device includes the second structure which is configured to house the second set of cameras. Each of these cameras is controllably moveable in synchronization with the first and third sets of cameras. The video capture device also includes the third, overhead structure that is configured to house the third set of cameras. Each of those cameras is controllably moveable in synchronization with the first and second sets of cameras. The video capture device further includes a controller configured to generate and send control signals to the first, second, and third sets of cameras to track the specified entity as the entity moves within a defined space that is observable by the first, second, and third sets of cameras housed in the first, second, and third structures.

Additionally, a mobile system, apparatus, or video capture device may be provided that includes a first mobile structure configured to house a first plurality of cameras, each camera being controllably moveable in synchronization with a second plurality of cameras on a second mobile structure and a third plurality of cameras on a third, overhead mobile structure, wherein the first, second, and third pluralities of cameras are controllably directed towards at least one specified entity. This mobile system, apparatus, or video capture device further includes a second mobile structure configured to house the second plurality of cameras, where each camera is controllably moveable in synchronization with the first and third pluralities of cameras. Still further, the mobile system, apparatus, or video capture device includes a third, overhead mobile structure configured to house the third plurality of cameras, where each camera is controllably moveable in synchronization with the first and second pluralities of cameras. The mobile system, apparatus, or video capture device also includes a controller configured to generate and send control signals to the first, second, and third pluralities of cameras to track the specified entity as the specified entity moves within a substantially unbounded area that is viewable by the cameras housed in the first, second, and third structures as the cameras move with the specified entity.

In some cases, the first mobile structure, the second mobile structure, and/or the third, overhead mobile structure include one or more powered wheels. In such cases, the controller generates and sends control signals to control the powered wheels. In some embodiments, the controller directs the first mobile structure, the second mobile structure, or the third mobile structure to follow and maintain a specified distance away from the specified entity. The controller features described above in conjunction with the stationary video capture device also apply to the mobile video capture device described herein.

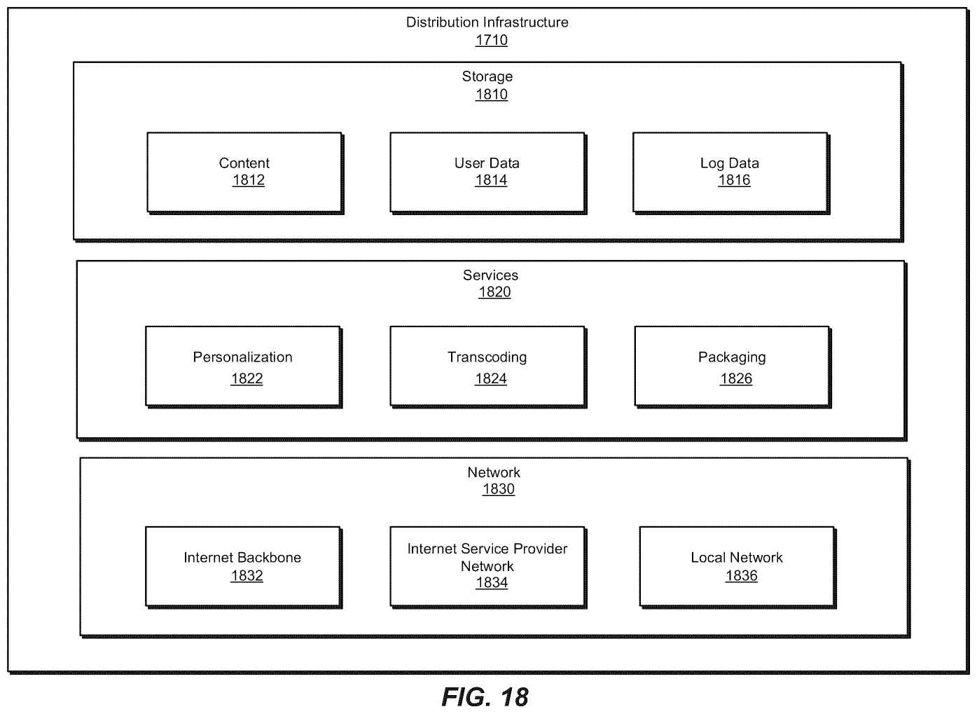

The following will provide, with reference to FIG. 17, detailed descriptions of exemplary ecosystems in which content, including videos created by combining multiple video feeds, is provisioned to end nodes and in which requests for content are steered to specific end nodes. The discussion corresponding to FIGS. 17 and 18 presents an overview of an exemplary distribution infrastructure and an exemplary content player used during playback sessions, respectively. These exemplary ecosystems and distribution infrastructures are implemented in any of the embodiments described above with reference to FIGS. 1-15.

FIG. 17 is a block diagram of a content distribution ecosystem 1700 that includes a distribution infrastructure 1710 in communication with a content player 1720. In some embodiments, distribution infrastructure 1710 is configured to encode data at a specific data rate and to transfer the encoded data to content player 1720. Content player 1720 is configured to receive the encoded data via distribution infrastructure 1710 and to decode the data for playback to a user. The data provided by distribution infrastructure 1710 includes, for example, audio, video, text, images, animations, interactive content, haptic data, virtual or augmented reality data, location data, gaming data, or any other type of data that is provided via streaming.

Distribution infrastructure 1710 generally represents any services, hardware, software, or other infrastructure components configured to deliver content to end users. For example, distribution infrastructure 1710 includes content aggregation systems, media transcoding and packaging services, network components, and/or a variety of other types of hardware and software. In some cases, distribution infrastructure 1710 is implemented as a highly complex distribution system, a single media server or device, or anything in between. In some examples, regardless of size or complexity, distribution infrastructure 1710 includes at least one physical processor 1712 and at least one memory device 1714. One or more modules 1716 are stored or loaded into memory 1714 to enable adaptive streaming, as discussed herein.

Content player 1720 generally represents any type or form of device or system capable of playing audio and/or video content that has been provided over distribution infrastructure 1710. Examples of content player 1720 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 1710, content player 1720 includes a physical processor 1722, memory 1724, and one or more modules 1726. Some or all of the adaptive streaming processes described herein is performed or enabled by modules 1726, and in some examples, modules 1716 of distribution infrastructure 1710 coordinate with modules 1726 of content player 1720 to provide adaptive streaming of digital content.

In certain embodiments, one or more of modules 1716 and/or 1726 in FIG. 17 represent one or more software applications or programs that, when executed by a computing device, cause the computing device to perform one or more tasks. For example, and as will be described in greater detail below, one or more of modules 1716 and 1726 represent modules stored and configured to run on one or more general-purpose computing devices. One or more of modules 1716 and 1726 in FIG. 17 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 1712 and 1722 generally represent any type or form of hardware-implemented processing unit capable of interpreting and/or executing computer-readable instructions. In one example, physical processors 1712 and 1722 access and/or modify one or more of modules 1716 and 1726, respectively. Additionally or alternatively, physical processors 1712 and 1722 execute one or more of modules 1716 and 1726 to facilitate adaptive streaming of digital content. Examples of physical processors 1712 and 1722 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 1714 and 1724 generally represent any type or form of volatile or non-volatile storage device or medium capable of storing data and/or computer-readable instructions. In one example, memory 1714 and/or 1724 stores, loads, and/or maintains one or more of modules 1716 and 1726. Examples of memory 1714 and/or 1724 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 18 is a block diagram of exemplary components of content distribution infrastructure 1810 according to certain embodiments. Distribution infrastructure 1810 includes storage 1810, services 1820, and a network 1830. Storage 1810 generally represents any device, set of devices, and/or systems capable of storing content for delivery to end users. Storage 1810 includes a central repository with devices capable of storing terabytes or petabytes of data and/or includes distributed storage systems (e.g., appliances that mirror or cache content at Internet interconnect locations to provide faster access to the mirrored content within certain regions). Storage 1810 is also configured in any other suitable manner.

As shown, storage 1810 may store a variety of different items including content 1812, user data 1814, and/or log data 1816. Content 1812 includes television shows, movies, video games, user-generated content, and/or any other suitable type or form of content. User data 1814 includes personally identifiable information (PII), payment information, preference settings, language and accessibility settings, and/or any other information associated with a particular user or content player. Log data 1816 includes viewing history information, network throughput information, and/or any other metrics associated with a user's connection to or interactions with distribution infrastructure 1610.

Services 1820 includes personalization services 1822, transcoding services 1824, and/or packaging services 1826. Personalization services 1822 personalize recommendations, content streams, and/or other aspects of a user's experience with distribution infrastructure 1610. Encoding services 1824 compress media at different bitrates which, as described in greater detail below, enable real-time switching between different encodings. Packaging services 1826 package encoded video before deploying it to a delivery network, such as network 1830, for streaming.

Network 1830 generally represents any medium or architecture capable of facilitating communication or data transfer. Network 1830 facilitates communication or data transfer using wireless and/or wired connections. Examples of network 1830 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 18, network 1830 includes an Internet backbone 1832, an internet service provider 1834, and/or a local network 1836. As discussed in greater detail below, bandwidth limitations and bottlenecks within one or more of these network segments triggers video and/or audio bit rate adjustments.

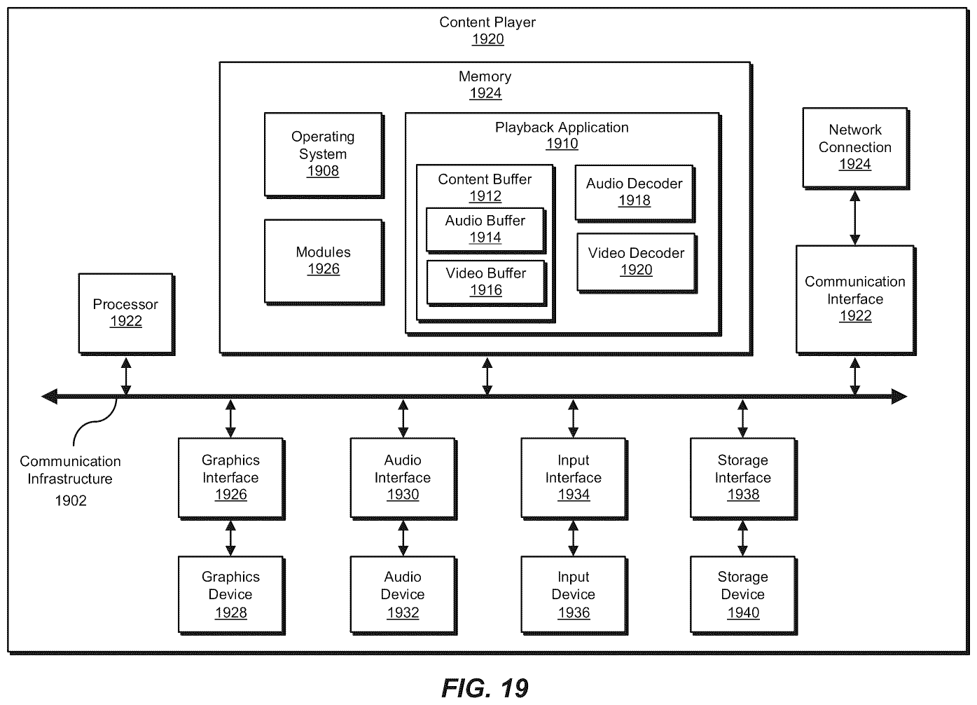

FIG. 19 is a block diagram of an exemplary implementation of content player 1620 of FIG. 16. Content player 1620 generally represents any type or form of computing device capable of reading computer-executable instructions. Content player 1620 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 19, in addition to processor 1622 and memory 1624, content player 1620 includes a communication infrastructure 1902 and a communication interface 1922 coupled to a network connection 1924. Content player 1620 also includes a graphics interface 1926 coupled to a graphics device 1928, an input interface 1934 coupled to an input device 1936, and a storage interface 1938 coupled to a storage device 1940.

Communication infrastructure 1902 generally represents any type or form of infrastructure capable of facilitating communication between one or more components of a computing device. Examples of communication infrastructure 1902 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 1624 generally represents any type or form of volatile or non-volatile storage device or medium capable of storing data and/or other computer-readable instructions. In some examples, memory 1624 stores and/or loads an operating system 1908 for execution by processor 1622. In one example, operating system 1908 includes and/or represents software that manages computer hardware and software resources and/or provides common services to computer programs and/or applications on content player 1620.

Operating system 1908 performs various system management functions, such as managing hardware components (e.g., graphics interface 1926, audio interface 1930, input interface 1934, and/or storage interface 1938). Operating system 1908 also provides process and memory management models for playback application 1910. The modules of playback application 1910 includes, for example, a content buffer 1912, an audio decoder 1918, and a video decoder 1920.

Playback application 1910 is configured to retrieve digital content via communication interface 1922 and play the digital content through graphics interface 1926. Graphics interface 1926 is configured to transmit a rendered video signal to graphics device 1928. In normal operation, playback application 1910 receives a request from a user to play a specific title or specific content. Playback application 1910 then identifies one or more encoded video and audio streams associated with the requested title. After playback application 1910 has located the encoded streams associated with the requested title, playback application 1910 downloads sequence header indices associated with each encoded stream associated with the requested title from distribution infrastructure 1610. A sequence header index associated with encoded content includes information related to the encoded sequence of data included in the encoded content.

In one embodiment, playback application 1910 begins downloading the content associated with the requested title by downloading sequence data encoded to the lowest audio and/or video playback bitrates to minimize startup time for playback. The requested digital content file is then downloaded into content buffer 1912, which is configured to serve as a first-in, first-out queue. In one embodiment, each unit of downloaded data includes a unit of video data or a unit of audio data. As units of video data associated with the requested digital content file are downloaded to the content player 1620, the units of video data are pushed into the content buffer 1912. Similarly, as units of audio data associated with the requested digital content file are downloaded to the content player 1620, the units of audio data are pushed into the content buffer 1912. In one embodiment, the units of video data are stored in video buffer 1916 within content buffer 1912 and the units of audio data are stored in audio buffer 1914 of content buffer 1912.

A video decoder 1920 reads units of video data from video buffer 1916 and outputs the units of video data in a sequence of video frames corresponding in duration to the fixed span of playback time. Reading a unit of video data from video buffer 1916 effectively de-queues the unit of video data from video buffer 1916. The sequence of video frames is then rendered by graphics interface 1926 and transmitted to graphics device 1928 to be displayed to a user.

An audio decoder 1918 reads units of audio data from audio buffer 1914 and outputs the units of audio data as a sequence of audio samples, generally synchronized in time with a sequence of decoded video frames. In one embodiment, the sequence of audio samples is transmitted to audio interface 1930, which converts the sequence of audio samples into an electrical audio signal. The electrical audio signal is then transmitted to a speaker of audio device 1932, which, in response, generates an acoustic output.

In situations where the bandwidth of distribution infrastructure 1610 is limited and/or variable, playback application 1910 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 1926 is configured to generate frames of video data and transmit the frames of video data to graphics device 1928. In one embodiment, graphics interface 1926 is included as part of an integrated circuit, along with processor 1622. Alternatively, graphics interface 1926 is configured as a hardware accelerator that is distinct from (i.e., is not integrated within) a chipset that includes processor 1622.

Graphics interface 1926 generally represents any type or form of device configured to forward images for display on graphics device 1928. For example, graphics device 1928 is fabricated using liquid crystal display (LCD) technology, cathode-ray technology, and light-emitting diode (LED) display technology (either organic or inorganic). In some embodiments, graphics device 1928 also includes a virtual reality display and/or an augmented reality display. Graphics device 1928 includes any technically feasible means for generating an image for display. In other words, graphics device 1928 generally represents any type or form of device capable of visually displaying information forwarded by graphics interface 1926.

As illustrated in FIG. 19, content player 1620 also includes at least one input device 1936 coupled to communication infrastructure 1902 via input interface 1934. Input device 1936 generally represents any type or form of computing device capable of providing input, either computer or human generated, to content player 1620. Examples of input device 1936 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 1620 also includes a storage device 1940 coupled to communication infrastructure 1902 via a storage interface 1938. Storage device 1940 generally represents any type or form of storage device or medium capable of storing data and/or other computer-readable instructions. For example, storage device 1940 is a magnetic disk drive, a solid-state drive, an optical disk drive, a flash drive, or the like. Storage interface 1938 generally represents any type or form of interface or device for transferring data between storage device 1940 and other components of content player 1620.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

### Example Embodiments

Example 1: A system includes: a first structure configured to house a first plurality of cameras, each camera being controllably moveable in synchronization with a second plurality of cameras on a second structure and with a third plurality of cameras on a third, overhead structure, wherein the first, second, and third pluralities of cameras are controllably directed toward at least one specified entity; the second structure configured to house the second plurality of cameras, each camera being controllably moveable in synchronization with the first and third pluralities of cameras; the third, overhead structure configured to house the third plurality of cameras, each camera being controllably moveable in synchronization with the first and second pluralities of cameras; and a controller configured to generate and send control signals to the first, second, and third pluralities of cameras to track the specified entity as the specified entity moves within a defined space that is observable by the first, second, and third pluralities of cameras housed in the first, second, and third structures.

Example 2. The system of Example 1, further comprising at least one modular flooring element, wherein the modular flooring element includes at least one portion of transparent material and at least one camera underneath the portion of transparent material.

Example 3. The system of Example 1 or Example 2, wherein the camera underneath the portion of transparent material in the modular flooring element is configured to pivot from a central axis to maintain focus on the specified entity.

Example 4. The system of any of Examples 1-3, wherein at least one of the first structure or the second structure is positioned on the modular flooring element.

Example 5. The system of any of Examples 1-4, wherein the controller additionally generates and sends control signals to the camera underneath the portion of transparent material in the modular flooring element to track the specified entity as the specified entity moves within the defined space.

Example 6. The system of any of Examples 1-5, further comprising at least one dynamic ceiling element that is part of a dynamic ceiling, wherein the dynamic ceiling element comprises a structural component and at least one controllably moveable camera mounted thereto.

Example 7. The system of any of Examples 1-6, wherein the structural component of the dynamic ceiling element is configured to telescope upward or downward relative to the dynamic ceiling.

Example 8. The system of any of Examples 1-7, wherein the dynamic ceiling comprises a plurality of telescoping, dynamic ceiling elements, each with controllably moveable cameras attached thereto.

Example 9. The system of any of Examples 1-8, wherein the plurality of telescoping, dynamic ceiling elements dynamically telescope upward or downward based on a current position of the specified entity.

Example 10. The system of any of Examples 1-9, wherein the telescoping, dynamic ceiling elements include one or more vertical actuators that activate telescoping upon receiving a specified control signal.

Example 11. The system of any of Examples 1-10, wherein at least one of the cameras in the first, second, or third pluralities of cameras includes a motorized zoom lens. In some cases, the motorized zoom lens implements at least one of a rolling shutter or a global shutter.

Example 12. The system of any of Examples 1-11, wherein at least one of the cameras in the first, second, or third pluralities of cameras includes an infrared light sensor configured to detect textures associated with the specified entity.

Example 13. The system of any of Examples 1-12, further comprising at least one laser configured to track movements of and follow the specified entity.

Example 14. The system of any of Examples 1-13, wherein the first, second, and third pluralities of cameras are configured to track a plurality of specified entities as the plurality of specified entities moves within the defined space that is viewable by the cameras in the first, second, and third structures.

Example 15. An apparatus comprises: a first structure configured to house a first plurality of cameras, each camera being controllably moveable in synchronization with a second plurality of cameras on a second structure and with a third plurality of cameras on a third, overhead structure, wherein the first, second, and third pluralities of cameras are controllably directed toward at least one specified entity; the second structure configured to house the second plurality of cameras, each camera being controllably moveable in synchronization with the first and third pluralities of cameras; the third, overhead structure configured to house the third plurality of cameras, each camera being controllably moveable in synchronization with the first and second pluralities of cameras; and a controller configured to generate and send control signals to the first, second, and third pluralities of cameras to track the specified entity as the specified entity moves within a defined space that is observable by the first, second, and third pluralities of cameras housed in the first, second, and third structures.

Example 16. The apparatus of Example 15, wherein at least one of the first structure, the second structure, or the third structure are mobile.

Example 17. The apparatus of Example 15 or Example 16, wherein the controller directs the first structure, the second structure, or the third structure to follow and maintain a specified distance away from the specified entity.

Example 18. The apparatus of Examples 15-17, further comprising a processor configured to stitch video feeds from the first, second, and/or third pluralities of cameras into a combined video feed.

Example 19. The apparatus of any of Examples 15-18, wherein the processor uses the combined video feed to create a three-dimensional model of the specified entity.

Example 20. A video capture device comprises: a first structure configured to house a first plurality of cameras, each camera being controllably moveable in synchronization with a second plurality of cameras on a second structure and with a third plurality of cameras on a third, overhead structure, wherein the first, second, and third pluralities of cameras are controllably directed toward at least one specified entity; the second structure configured to house the second plurality of cameras, each camera being controllably moveable in synchronization with the first and third pluralities of cameras; the third, overhead structure configured to house the third plurality of cameras, each camera being controllably moveable in synchronization with the first and second pluralities of cameras; and a controller configured to generate and send control signals to the first, second, and third pluralities of cameras to track the specified entity as the specified entity moves within a defined space that is observable by the first, second, and third pluralities of cameras housed in the first, second, and third structures.

Example 21. A system comprises: a first mobile structure configured to house a first plurality of cameras, each camera being controllably moveable in synchronization with a second plurality of cameras on a second mobile structure and a third plurality of cameras on a third, overhead mobile structure, wherein the first, second, and third pluralities of cameras are controllably directed towards at least one specified entity; the second mobile structure configured to house the second plurality of cameras, each camera being controllably moveable in synchronization with the first and third pluralities of cameras; the third, overhead mobile structure configured to house the third plurality of cameras, each camera being controllably moveable in synchronization with the first and second pluralities of cameras; and a controller configured to generate and send control signals to the first, second, and third pluralities of cameras to track the specified entity as the specified entity moves within a substantially unbounded area that is viewable by the cameras housed in the first, second, and third structures as the cameras move with the specified entity.

Example 22. The system of Example 21, wherein at least one of the first mobile structure, the second mobile structure, or the third, overhead mobile structure include one or more powered wheels, and where the controller generates and sends control signals to control the powered wheels.

Example 23. The system of Example 21 or Example 22, wherein the controller directs the first mobile structure, the second mobile structure, or the third mobile structure to follow and maintain a specified distance away from the specified entity.

Example 24. The system of any of Examples 21-23 further comprising any of the components or configurations described in Examples 1-23.

Example 25. A computer-implemented method comprising: receiving a first video feed from a first plurality of cameras mounted in a first structure, wherein each camera is controllably moveable in synchronization with a second plurality of cameras on a second structure and with a third plurality of cameras on a third, overhead structure, wherein the first, second, and third pluralities of cameras are controllably directed toward at least one specified entity, and wherein the first video feed includes first metadata comprising dynamically updated camera operating information for the first plurality of cameras; receiving a second video feed from the second plurality of cameras, wherein each camera is controllably moveable in synchronization with the first and third pluralities of cameras, and wherein the second video feed includes second metadata comprising dynamically updated camera operating information for the second plurality of cameras; receiving a third video feed from the third plurality of cameras, wherein each camera is controllably moveable in synchronization with the first and second pluralities of cameras, and wherein the third video feed includes third metadata comprising dynamically updated camera operating information for the third plurality of cameras; and combining, using the first, second, and third metadata, at least a portion of the first video feed, the second video feed, and the third video feed into a single vide feed that tracks the specified entity as the specified entity moves within a defined space that is observable by the first, second, and third pluralities of cameras.

Example 26. The computer-implemented method of Example 25, wherein the combining of the first, second, and third video feeds includes removing at least a portion of video feed data from each video feed.

Example 27. The computer-implemented method of Example 25 or Example 26, wherein the combining of the first, second, and third video feeds includes identifying the specified entity and identifying which video frames from each video feed include the specified entity.

Example 28. The computer-implemented method of any of Examples 25-27, wherein identifying which video frames from each video feed include the specified entity comprises determining whether the video frames include a minimum threshold amount of the specified entity in the video frame.

Example 29. The computer-implemented method of any of Examples 25-28, wherein identifying which video frames from each video feed include the specified entity comprises determining whether the video frames include the specified entity at a minimum threshold quality level.

Example 30. The computer-implemented method of any of Examples 25-29, wherein identifying which video frames from each video feed include the specified entity comprises determining whether the video frames include the specified entity at a specified angle.

Example 31. The computer-implemented method of any of Examples 25-30 further comprising any of the components or configurations described in Examples 1-24.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a first structure configured to house a first plurality of cameras, each camera being controllably moveable in synchronization with a second plurality of cameras on a second structure and with a third plurality of cameras on a third, overhead structure, wherein the first, second, and third pluralities of cameras are controllably directed toward at least one specified entity;
the second structure configured to house the second plurality of cameras, each camera being controllably moveable in synchronization with the first and third pluralities of cameras;
the third, overhead structure configured to house the third plurality of cameras, each camera being controllably moveable in synchronization with the first and second pluralities of cameras; and
a controller configured to generate and send control signals to the first, second, and third pluralities of cameras to track the specified entity as the specified entity moves within a defined space that is observable by the first, second, and third pluralities of cameras housed in the first, second, and third structures.

2. The system of claim 1, further comprising at least one modular flooring element, wherein the modular flooring element includes at least one portion of transparent material and at least one camera underneath the portion of transparent material.

3. The system of claim 2, wherein the camera underneath the portion of transparent material in the modular flooring element is configured to pivot from a central axis to maintain focus on the specified entity.

4. The system of claim 2, wherein at least one of the first structure or the second structure is positioned on the modular flooring element.

5. The system of claim 2, wherein the controller additionally generates and sends control signals to the camera underneath the portion of transparent material in the modular flooring element to track the specified entity as the specified entity moves within the defined space.

6. The system of claim 1, further comprising at least one dynamic ceiling element that is part of a dynamic ceiling, wherein the dynamic ceiling element comprises a structural component and at least one controllably moveable camera mounted thereto.

7. The system of claim 6, wherein the structural component of the dynamic ceiling element is configured to telescope upward or downward relative to the dynamic ceiling.

8. The system of claim 7, wherein the dynamic ceiling comprises a plurality of telescoping, dynamic ceiling elements, each with controllably moveable cameras attached thereto.

9. The system of claim 8, wherein the plurality of telescoping, dynamic ceiling elements dynamically telescope upward or downward based on a current position of the specified entity.

10. The system of claim 7, wherein the telescoping, dynamic ceiling elements include one or more vertical actuators that activate telescoping upon receiving a specified control signal.

11. The system of claim 1, wherein at least one of the cameras in the first, second, or third pluralities of cameras includes a motorized zoom lens.

12. The system of claim 1, wherein at least one of the cameras in the first, second, or third pluralities of cameras includes an infrared light sensor configured to detect textures associated with the specified entity.

13. The system of claim 1, further comprising at least one laser configured to track movements of and follow the specified entity.

14. The system of claim 1, wherein the first, second, and third pluralities of cameras are configured to track a plurality of specified entities as the plurality of specified entities moves within the defined space that is viewable by the cameras in the first, second, and third structures.

15. An apparatus comprising:
a first structure configured to house a first plurality of cameras, each camera being controllably moveable in synchronization with a second plurality of cameras on a second structure and with a third plurality of cameras on a third, overhead structure, wherein the first, second, and third pluralities of cameras are controllably directed toward at least one specified entity;
the second structure configured to house the second plurality of cameras, each camera being controllably moveable in synchronization with the first and third pluralities of cameras;
the third, overhead structure configured to house the third plurality of cameras, each camera being controllably moveable in synchronization with the first and second pluralities of cameras; and
a controller configured to generate and send control signals to the first, second, and third pluralities of cameras to track the specified entity as the specified entity moves within a defined space that is observable by the first, second, and third pluralities of cameras housed in the first, second, and third structures.

16. The apparatus of claim 15, wherein at least one of the first structure, the second structure, or the third structure are mobile.

17. The apparatus of claim 16, wherein the controller directs the first structure, the second structure, or the third structure to follow and maintain a specified distance away from the specified entity.

18. The apparatus of claim 15, further comprising a processor configured to stitch video feeds from the first, second, and/or third pluralities of cameras into a combined video feed.

19. The apparatus of claim 18, wherein the processor uses the combined video feed to create a three-dimensional model of the specified entity.

20. A video capture device comprising:
a first structure configured to house a first plurality of cameras, each camera being controllably moveable in synchronization with a second plurality of cameras on a second structure and with a third plurality of cameras on a third, overhead structure, wherein the first, second, and third pluralities of cameras are controllably directed toward at least one specified entity;
the second structure configured to house the second plurality of cameras, each camera being controllably moveable in synchronization with the first and third pluralities of cameras;
the third, overhead structure configured to house the third plurality of cameras, each camera being controllably moveable in synchronization with the first and second pluralities of cameras; and
a controller configured to generate and send control signals to the first, second, and third pluralities of cameras to track the specified entity as the specified entity moves within a defined space that is observable by the first, second, and third pluralities of cameras housed in the first, second, and third structures.
